(19) United States
(12) Patent Application Publication
(10) Pub. No.: US 2025/0118318 A1
(43) Pub. Date: Apr. 10, 2025

(54) MACHINE-LEARNING BASED AUDIO SUBBAND PROCESSING

(71) Applicant: QUALCOMM Incorporated, San Diego, CA (US)

(72) Inventors: Vahid MONTAZERI, Newport Beach, CA (US); Rogerio Guedes ALVES, Macomb Township, MI (US); Erik VISSER, San Diego, CA (US)

(21) Appl. No.: 18/907,321

(22) Filed: Oct. 4, 2024

Related U.S. Application Data
(60) Provisional application No. 63/589,120, filed on Oct. 10, 2023.

(51) Int. Cl. G10L 21/0208; G10L 21/0216; G10L 21/038

(52) U.S. Cl. CPC G10L 21/0208; G10L 21/038; G10L 2021/02166

(57) ABSTRACT

A device includes a memory configured to store audio data. The device also includes one or more processors configured to use a first machine-learning model to process first audio data to generate first spatial sector audio data. The first spatial sector audio data is associated with a first spatial sector. The one or more processors are also configured to use a second machine-learning model to process second audio data to generate second spatial sector audio data. The second spatial sector audio data is associated with a second spatial sector. The one or more processors are further configured to generate output data based on the first spatial sector audio data, the second spatial sector audio data, or both.

### I. CROSS-REFERENCE TO RELATED APPLICATIONS

The present application claims priority from Provisional Patent Application No. 63/589,120, filed Oct. 10, 2023, entitled “MACHINE-LEARNING BASED AUDIO SUBBAND PROCESSING,” the content of which is incorporated herein by reference in its entirety.

### II. FIELD

The present disclosure is generally related to machine-learning based audio subband processing.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to receive an audio signal from one or more microphones. For example, the audio signal may represent user speech captured by the microphones, external sounds captured by the microphones, or a combination thereof. The audio signal can include noise, echo, or other artifacts that adversely impact audio quality.

### IV. SUMMARY

According to one aspect of the present disclosure, a device includes a memory configured to store audio data. The device also includes one or more processors configured to obtain, from first audio data, first subband audio data and second subband audio data. The first subband audio data is associated with a first frequency subband and the second subband audio data is associated with a second frequency subband. The one or more processors are also configured to use a first machine-learning model to process the first subband audio data to generate first subband noise suppressed audio data. The one or more processors are further configured to use a second machine-learning model to process the second subband audio data to generate second subband noise suppressed audio data. The one or more processors are also configured to generate output data based on the first subband noise suppressed audio data and the second subband noise suppressed audio data.

According to another aspect of the present disclosure, a device includes a memory configured to store audio data. The device also includes one or more processors configured to obtain reference audio data representing far end audio. The one or more processors are also configured to obtain near end audio data. The one or more processors are further configured to obtain, from the near end audio data, first subband audio data and second subband audio data. The first subband audio data is associated with a first frequency subband and the second subband audio data is associated with a second frequency subband. The one or more processors are also configured to obtain, from the reference audio data, first subband reference audio data and second subband reference audio data. The first subband reference audio data is associated with the first frequency subband and the second subband reference audio data is associated with the second frequency subband. The one or more processors are further configured to use a first machine-learning model to process the first subband audio data and the first subband reference audio data to generate first subband intermediate audio data. The one or more processors are also configured to use a second machine-learning model to process the second subband audio data and the second subband reference audio data to generate second subband intermediate audio data. Each of the first subband intermediate audio data and the second subband intermediate audio data corresponds to echo suppressed audio. The one or more processors are further configured to generate output data based on the first subband intermediate audio data and the second subband intermediate audio data.

According to another aspect of the present disclosure, a device includes a memory configured to store audio data. The device also includes one or more processors configured to use a first machine-learning model to process first audio data to generate first spatial sector audio data. The first spatial sector audio data is associated with a first spatial sector. The one or more processors are also configured to use a second machine-learning model to process second audio data to generate second spatial sector audio data. The second spatial sector audio data is associated with a second spatial sector. The one or more processors are also configured to generate output data based on the first spatial sector audio data, the second spatial sector audio data, or both.

According to another aspect of the present disclosure, a method includes obtaining, at a device, first subband audio data and second subband audio data from first audio data. The first subband audio data is associated with a first frequency subband and the second subband audio data is associated with a second frequency subband. The method also includes using, at the device, a first machine-learning model to process the first subband audio data to generate first subband noise suppressed audio data. The method further includes using, at the device, a second machine-learning model to process the second subband audio data to generate second subband noise suppressed audio data. The method also includes generating, at the device, output data based on the first subband noise suppressed audio data and the second subband noise suppressed audio data.

According to another aspect of the present disclosure, a method includes obtaining, at a device, reference audio data representing far end audio. The method also includes obtaining near end audio data at the device. The method further includes obtaining, at the device, first subband audio data and second subband audio data from the near end audio data. The first subband audio data is associated with a first frequency subband and the second subband audio data is associated with a second frequency subband. The method also includes obtaining, at the device, first subband reference audio data and second subband reference audio data from the reference audio data. The first subband reference audio data is associated with the first frequency subband and the second subband reference audio data is associated with the second frequency subband. The method further includes using, at the device, a first machine-learning model to process the first subband audio data and the first subband reference audio data to generate first subband intermediate audio data. The method further includes using, at the device, a second machine-learning model to process the second subband audio data and the second subband reference audio data to generate second subband intermediate audio data. Each of the first subband intermediate audio data and the second subband intermediate audio data corresponds to echo suppressed audio. The method further includes generating, at the device, output data based on the first subband intermediate audio data and the second subband intermediate audio data.

According to another aspect of the present disclosure, a method includes using, at a device, a first machine-learning model to process first audio data to generate first spatial sector audio data. The first spatial sector audio data is associated with a first spatial sector. The method also includes using, at the device, a second machine-learning model to process second audio data to generate second spatial sector audio data. The second spatial sector audio data is associated with a second spatial sector. The method further includes generating, at the device, output data based on the first spatial sector audio data, the second spatial sector audio data, or both.

According to another aspect of the present disclosure, a non-transitory computer-readable medium includes instructions that, when executed by one or more processors, cause the one or more processors to obtain first subband audio data and second subband audio data from first audio data. The first subband audio data is associated with a first frequency subband and the second subband audio data is associated with a second frequency subband. The instructions, when executed by the one or more processors, also cause the one or more processors to use a first machine-learning model to process the first subband audio data to generate first subband noise suppressed audio data. The instructions, when executed by the one or more processors, further cause the one or more processors to use a second machine-learning model to process the second subband audio data to generate second subband noise suppressed audio data. The instructions, when executed by the one or more processors, also cause the one or more processors to generate output data based on the first subband noise suppressed audio data and the second subband noise suppressed audio data.

According to another aspect of the present disclosure, a non-transitory computer-readable medium includes instructions that, when executed by one or more processors, cause the one or more processors to obtain reference audio data representing far end audio. The instructions, when executed by the one or more processors, also cause the one or more processors to obtain near end audio data. The instructions, when executed by the one or more processors, further cause the one or more processors to obtain first subband audio data and second subband audio data from the near end audio data. The first subband audio data is associated with a first frequency subband and the second subband audio data is associated with a second frequency subband. The instructions, when executed by the one or more processors, also cause the one or more processors to obtain first subband reference audio data and second subband reference audio data from the reference audio data. The first subband reference audio data is associated with the first frequency subband and the second subband reference audio data is associated with the second frequency subband. The instructions, when executed by the one or more processors, further cause the one or more processors to use a first machine-learning model to process the first subband audio data and the first subband reference audio data to generate first subband intermediate audio data. The instructions, when executed by the one or more processors, also cause the one or more processors to use a second machine-learning model to process the second subband audio data and the second subband reference audio data to generate second subband intermediate audio data. Each of the first subband intermediate audio data and the second subband intermediate audio data corresponds to echo suppressed audio. The instructions, when executed by the one or more processors, further cause the one or more processors to generate output data based on the first subband intermediate audio data and the second subband intermediate audio data.

According to another aspect of the present disclosure, a non-transitory computer-readable medium includes instructions that, when executed by one or more processors, cause the one or more processors to use a first machine-learning model to process first audio data to generate first spatial sector audio data. The first spatial sector audio data is associated with a first spatial sector. The instructions, when executed by the one or more processors, also cause the one or more processors to use a second machine-learning model to process second audio data to generate second spatial sector audio data. The second spatial sector audio data is associated with a second spatial sector. The instructions, when executed by the one or more processors, further cause the one or more processors to generate output data based on the first spatial sector audio data, the second spatial sector audio data, or both.

According to another aspect of the present disclosure, an apparatus includes means for obtaining first subband audio data and second subband audio data from first audio data. The first subband audio data is associated with a first frequency subband and the second subband audio data is associated with a second frequency subband. The apparatus also includes means for using a first machine-learning model to process the first subband audio data to generate first subband noise suppressed audio data. The apparatus further includes means for using a second machine-learning model to process the second subband audio data to generate second subband noise suppressed audio data. The apparatus also includes means for generating output data based on the first subband noise suppressed audio data and the second subband noise suppressed audio data.

According to another aspect of the present disclosure, an apparatus includes means for obtaining reference audio data representing far end audio. The apparatus also includes means for obtaining near end audio data. The apparatus further includes means for obtaining first subband audio data and second subband audio data from the near end audio data. The first subband audio data is associated with a first frequency subband and the second subband audio data is associated with a second frequency subband. The apparatus also includes means for obtaining first subband reference audio data and second subband reference audio data from the reference audio data. The first subband reference audio data is associated with the first frequency subband and the second subband reference audio data is associated with the second frequency subband. The apparatus further includes means for using a first machine-learning model to process the first subband audio data and the first subband reference audio data to generate first subband intermediate audio data. The apparatus also includes means for using a second machine-learning model to process the second subband audio data and the second subband reference audio data to generate second subband intermediate audio data. Each of the first subband intermediate audio data and the second subband intermediate audio data corresponds to echo suppressed audio. The apparatus further includes means for generating output data based on the first subband intermediate audio data and the second subband intermediate audio data.

According to another aspect of the present disclosure, an apparatus includes means for using a first machine-learning model to process first audio data to generate first spatial sector audio data. The first spatial sector audio data is associated with a first spatial sector. The apparatus also includes means for using a second machine-learning model to process second audio data to generate second spatial sector audio data. The second spatial sector audio data is associated with a second spatial sector. The apparatus further includes means for generating output data based on the first spatial sector audio data, the second spatial sector audio data, or both.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative aspect of a system operable to perform machine-learning based audio subband processing, in accordance with some examples of the present disclosure.

FIG. 2 is a diagram of an illustrative aspect of a system operable to perform machine-learning based audio subband processing, in accordance with some examples of the present disclosure.

FIG. 3 is a diagram of an illustrative aspect of a system operable to perform machine-learning based audio subband processing, in accordance with some examples of the present disclosure.

FIG. 4A is a diagram of an illustrative aspect of a system operable to perform machine-learning based audio subband processing, in accordance with some examples of the present disclosure.

FIG. 4B is a diagram of examples of an illustrative aspect of operation of components of the system of FIG. 4A, in accordance with some examples of the present disclosure.

FIG. 5 is a diagram of an illustrative aspect of a system operable to perform machine-learning based audio subband processing, in accordance with some examples of the present disclosure.

FIG. 6A is a diagram of an illustrative aspect of a system operable to perform machine-learning based audio subband processing, in accordance with some examples of the present disclosure.

FIG. 6B is a diagram of an illustrative aspect of a system operable to perform machine-learning based audio subband processing, in accordance with some examples of the present disclosure.

FIG. 7 is a diagram of an illustrative aspect of components of a system of any of FIGS. 1-6B, in accordance with some examples of the present disclosure.

FIG. 8 is a diagram of an illustrative aspect of components of a system of any of FIGS. 1-6B, in accordance with some examples of the present disclosure.

FIG. 9 is a diagram of an illustrative example of output of machine-learning based audio subband processing, in accordance with some examples of the present disclosure.

FIG. 10 is a diagram of an illustrative aspect of operation of components of a system of FIG. 4A, in accordance with some examples of the present disclosure.

FIG. 11 illustrates an example of an integrated circuit operable to perform machine-learning based audio subband processing, in accordance with some examples of the present disclosure.

FIG. 12 is a diagram of a mobile device operable to perform machine-learning based audio subband processing, in accordance with some examples of the present disclosure.

FIG. 13 is a diagram of a headset operable to perform machine-learning based audio subband processing, in accordance with some examples of the present disclosure.

FIG. 14 is a diagram of a wearable electronic device operable to perform machine-learning based audio subband processing, in accordance with some examples of the present disclosure.

FIG. 15 is a diagram of eye glasses operable to perform machine-learning based audio subband processing, in accordance with some examples of the present disclosure.

FIG. 16 is a diagram of ear buds operable to perform machine-learning based audio subband processing, in accordance with some examples of the present disclosure.

FIG. 17 is a diagram of a voice-controlled speaker system operable to perform machine-learning based audio subband processing, in accordance with some examples of the present disclosure.

FIG. 18 is a diagram of a camera operable to perform machine-learning based audio subband processing, in accordance with some examples of the present disclosure.

FIG. 19 is a diagram of a headset, such as a virtual reality, mixed reality, or augmented reality headset, operable to perform machine-learning based audio subband processing, in accordance with some examples of the present disclosure.

FIG. 20 is a diagram of a first example of a vehicle operable to perform machine-learning based audio subband processing, in accordance with some examples of the present disclosure.

FIG. 21 is a diagram of a second example of a vehicle operable to perform machine-learning based audio subband processing, in accordance with some examples of the present disclosure.

FIG. 22 is a diagram of a particular implementation of a method of machine-learning based audio subband processing that may be performed by a system of any of FIGS. 1-6, in accordance with some examples of the present disclosure.

FIG. 23 is a diagram of a particular implementation of a method of machine-learning based audio subband processing that may be performed by a system of any of FIGS. 1-6, in accordance with some examples of the present disclosure.

FIG. 24 is a diagram of a particular implementation of a method of machine-learning based audio subband processing that may be performed by a system of any of FIGS. 1-6, in accordance with some examples of the present disclosure.

FIG. 25 is a block diagram of a particular illustrative example of a device that is operable to perform machine-learning based audio subband processing, in accordance with some examples of the present disclosure.

### VI. DETAILED DESCRIPTION

Computing devices often incorporate functionality to receive audio signals from microphones. For example, an audio signal may represent user speech captured by the microphones, external sounds captured by the microphones, or a combination thereof. A problem with a microphone audio signal is that the audio signal can include noise, echo, or other artifacts that adversely impact audio quality. One solution to this problem is to process the audio signal to generate an enhanced audio signal with reduced noise, echo, or both. However, this solution leads to still further problems. To illustrate, certain audio segments may include both noise and speech. Processing an audio segment to remove noise can also remove speech. On the other hand, processing the audio segment to enhance speech can also enhance noise.

Aspects disclosed herein provide solutions to these, and other, problems by using independent machine-learning models to analyze and process respective frequency subbands of audio data, enabling appropriate processing by subband. Each of the independent machine-learning models is trained and optimized to process a respective subband. As one example, a low-frequency subband of an audio segment can correspond to speech while a high-frequency subband of the same audio segment corresponds to noise. A first machine-learning model processes low-frequency subband audio data to generate first enhanced subband audio data in which speech is retained or enhanced. A second machine-learning model processes high-frequency subband audio data to generate second enhanced subband audio data in which noise is reduced. A combiner is used to combine the first enhanced subband audio data and the second enhanced subband audio data to generate enhanced audio data.

A single machine-learning model to process a larger frequency band would be large and complex. This, and other problems, can be solved by separate machine-learning models trained to process different subbands that have lower complexity (e.g., fewer network nodes, network layers, etc.) and higher efficiency (e.g., faster processing time, fewer computing cycles, etc.) as compared to a single machine-learning model that is trained to process a larger frequency band that includes the subbands. For example, the first machine-learning model trained to retain speech in low-frequency subband audio and the second machine-learning model which is trained to reduce noise in the high-frequency subband audio have lower complexity and higher efficiency than a single machine-learning model that is trained to process a larger frequency band to reduce speech in the low-frequency subband audio and reduce noise in the high-frequency subband audio.

A problem of a machine-learning model for processing the larger frequency band is that the machine-learning model is better suited for processing some subbands than others. For example, a long short-term memory network (LSTM) based masking network can be better suited for processing low-frequency subband audio, whereas a convolutional neural network can be better suited for processing high-frequency subband audio. Independent machine-learning models can solve this problem by having different model architectures that are better suited to processing the respective subbands. In an example, the first machine-learning model that is trained to process low-frequency subband audio can include a LSTM-based masking network and the second machine-learning model that is trained to process high-frequency subband audio can include a convolutional neural network (e.g., U-Net) architecture. In some examples, procedural signal processing can be performed for audio enhancement of a particular subband, audio enhancement can be bypassed for another subband, or both.

A single large complex machine-learning model can have high resource usage (e.g., computing cycles, memory, etc.) that can limit the types of devices that can support the machine-learning model. This problem can be solved by independent machine-learning models that do not have to be co-located. For example, processing of the low-frequency subband audio can be performed at a first device that includes the first machine-learning model and processing of the high-frequency subband audio can be performed at a second device that includes the second machine-learning model. At least some of the subband audio processing can thus be offloaded to another device.

Reconfiguring a large machine-learning model can change processing for the entire frequency band. The independent machine-learning models can solve this problem by being independently configurable. For example, an updated configuration that is better suited for the low-frequency subband audio can be used for the first machine-learning model without changing the second machine-learning model. In another example, the second machine-learning model can be updated to have a second configuration that is better suited to the high-frequency subband audio. The configuration of the independent machine-learning models can be obtained from one or more sources, e.g., other devices, based on context of the audio.

In some cases, different microphones may capture audio that has better audio quality in different subbands. For example, a first microphone is nearer a first sound source (e.g., a speech source), and a second microphone is nearer a second sound source (e.g., a music source). In this example, first low-frequency subband audio data from the first microphone is selected for processing using a first machine-learning model to generate first enhanced subband audio data in which speech is retained or enhanced, and second high-frequency subband audio data from the second microphone is selected for processing using a second machine-learning model to generate second enhanced subband audio data in which music is retained or enhanced.

In some examples, a machine-learning model is used to process subband audio data from multiple microphones to generate enhanced subband audio data. A first machine-learning model is used to process first low-frequency subband audio data from a first microphone and second low-frequency subband audio data from a second microphone to generate enhanced low-frequency subband audio data. A second machine-learning model is used to process first high-frequency subband audio data from the first microphone and second high-frequency subband audio data from the second microphone to generate enhanced high-frequency subband audio data.

Processing audio data from multiple microphones can improve performance of machine-learning models. For example, the enhanced low-frequency subband audio data generated by the first machine-learning model that processes low-frequency subband audio data from multiple microphones can have enhanced speech and reduced noise as compared to enhanced low-frequency subband audio data based on low-frequency subband audio data from a single microphone. As another example, the enhanced high-frequency subband audio data generated by the second machine-learning model that processes high-frequency subband audio data from multiple microphones can have enhanced speech and reduced noise as compared to enhanced high-frequency subband audio data based on high-frequency subband audio data from a single microphone.

Separate machine-learning models that are trained to process different subbands can have lower complexity (e.g., fewer network nodes, network layers, etc.) and higher efficiency (e.g., faster processing time, fewer computing cycles, etc.) as compared to a single machine-learning model that is trained to process a larger frequency band that includes the subbands.

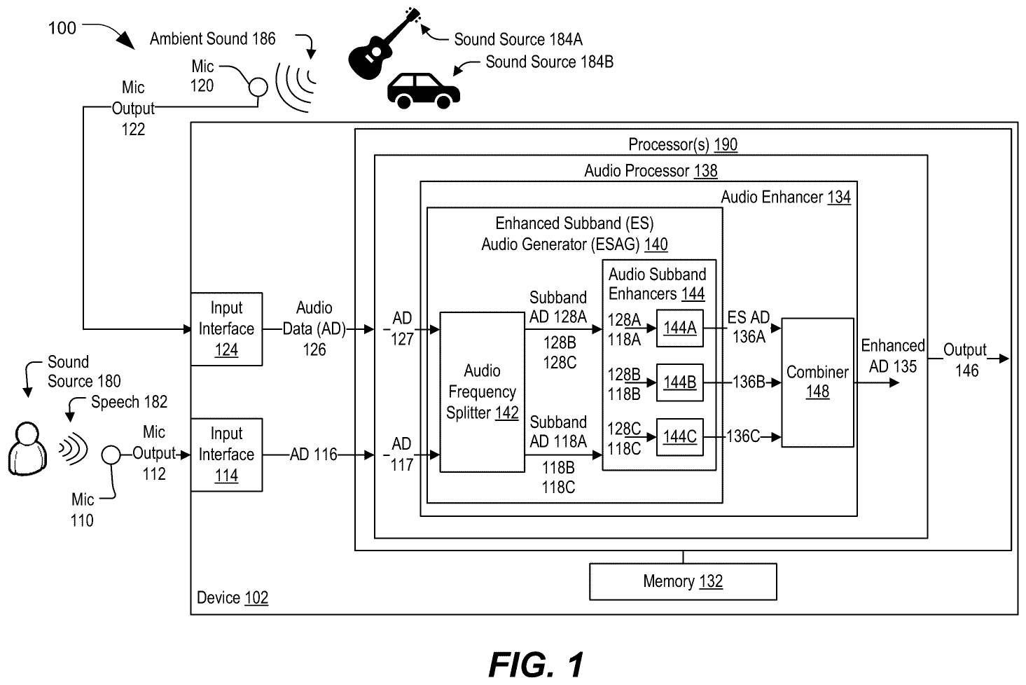

Particular aspects of the present disclosure are described below with reference to the drawings. In the description, common features are designated by common reference numbers. As used herein, various terminology is used for the purpose of describing particular embodiments only and is not intended to be limiting of embodiments. For example, the singular forms “a,” “an,” and “the” are intended to include the plural forms as well, unless the context clearly indicates otherwise. Further, some features described herein are singular in some embodiments and plural in other embodiments. To illustrate, FIG. 1 depicts a device 102 including one or more processors (“processor(s)” 190 of FIG. 1), which indicates that in some embodiments the device 102 includes a single processor 190 and in other embodiments the device 102 includes multiple processors 190. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 1, multiple sources are illustrated and associated with reference numbers 184A and 184B. When referring to a particular one of these sources, such as a sound source 184A, the distinguishing letter “A” is used. However, when referring to any arbitrary one of these sources or to these sources as a group, the reference number 184 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an embodiment, and/or an aspect, and should not be construed as limiting or as indicating a preference or a preferred embodiment. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In a particular embodiment, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows-a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In a particular embodiment, a model may be continuously, periodically, or occasionally updated, in which case training time and runtime may be interleaved or one version of the model can be used for inference while a copy is updated, after which the updated copy may be deployed for inference.

In a particular embodiment, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

As used herein, the term “procedural signal processing” should be understood to have any of its usual and customary meanings within the fields of signal processing, such meanings including, for example, performing a series of well-defined mathematical or computational operations that one or more computers are programmed to perform. As a typical example, procedural signal processing can include processing a signal (e.g., data) using one or more specific algorithms or procedures to generate a result. Procedural signal processing can encompass a wide range of tasks, including filtering, compression, modulation, demodulation, and feature extraction, as illustrative non-limiting examples.

Referring to FIG. 1, a particular illustrative aspect of a system configured to perform machine-learning based audio subband processing is disclosed and generally designated 100. The system 100 includes a device 102 that is coupled to a microphone 110, a microphone 120, one or more additional microphones, or a combination thereof. In a particular aspect, the device 102 is coupled to a microphone array that includes the microphone 110, the microphone 120, one or more additional microphones, or a combination thereof.

The device 102 includes one or more processors 190 coupled to a memory 132 that is configured to store audio data. The one or more processors 190 are also coupled to one or more input interfaces that are configured to be coupled to one or more microphones. For example, the device 102 includes an input interface 114 that is coupled to the one or more processors 190 and is configured to be coupled to the microphone 110. The input interface 114 is configured to receive a microphone output 112 from the microphone 110 and to provide the microphone output 112 to the one or more processors 190 as audio data (AD) 116. As another example, the device 102 includes an input interface 124 that is coupled to the one or more processors 190 and is configured to be coupled to the microphone 120. The input interface 124 is configured to receive a microphone output 122 from the microphone 120 and to provide the microphone output 122 to the one or more processors 190 as audio data 126.

In a particular optional embodiment, a microphone array is configured to generate the audio data 116 and the audio data 126. For example, a first subset of a microphone array includes the microphone 110 and the input interface 114 is configured to receive a microphone output 112 from the first subset of the microphone array and to provide the microphone output 112 to the one or more processors 190 as audio data 116. As another example, a second subset of the microphone array includes the microphone 120 and the input interface 124 is configured to receive a microphone output 122 from the second subset of the microphone array and to provide the microphone output 122 to the one or more processors 190 as audio data 126. In a particular optional embodiment, a beamformer is configured to process audio data to generate the audio data 116 and the audio data 126.

The one or more processors 190 include an audio processor 138. The audio processor 138 includes an audio enhancer 134. The audio enhancer 134 includes an enhanced subband audio generator (ESAG) 140 coupled to a combiner 148. The enhanced subband audio generator 140 includes an audio frequency splitter 142 coupled to audio subband enhancers 144.

The audio frequency splitter 142 is configured to obtain audio data corresponding to a frequency band and to generate sets of subband audio data corresponding to respective frequency subbands of the frequency band. For example, the audio frequency splitter 142 is configured to obtain audio data 117 corresponding to a frequency band (e.g., 0 to 16 kilohertz (kHz)) and to process the audio data 117 to generate subband audio data 118A corresponding to a first frequency subband of the frequency band, subband audio data 118B corresponding to a second frequency subband of the frequency band, subband audio data 118C corresponding to a third frequency subband of the frequency band, or a combination thereof. The audio data 117 is based on the audio data 116.

The audio subband enhancers 144 are configured to process subband audio data from one or more microphones of a particular frequency subband to generate enhanced subband audio data of the particular frequency subband. In an example, the audio subband enhancers 144 include an audio subband enhancer 144A corresponding to the first frequency subband, an audio subband enhancer 144B corresponding to the second frequency subband, an audio subband enhancer 144C corresponding to the third frequency subband, one or more additional audio subband enhancers corresponding to respective frequency subbands, or a combination thereof. The audio subband enhancer 144A is configured to process subband audio data corresponding to the first frequency subband to generate enhanced subband audio data 136A. For example, the audio subband enhancer 144A is configured to process the subband audio data 118A from the microphone 110, subband audio data 128A from the microphone 120, additional subband audio data from one or more additional microphones, or a combination thereof, to generate enhanced subband audio data 136A. The combiner 148 is configured to combine enhanced subband audio data corresponding to multiple frequency subbands to generate enhanced audio data 135 corresponding to a frequency band (e.g., 0 to 16 kHz). The audio enhancer 134 is configured to output the enhanced audio data 135. The audio processor 138 is configured to generate an output 146 based on the enhanced audio data 135.

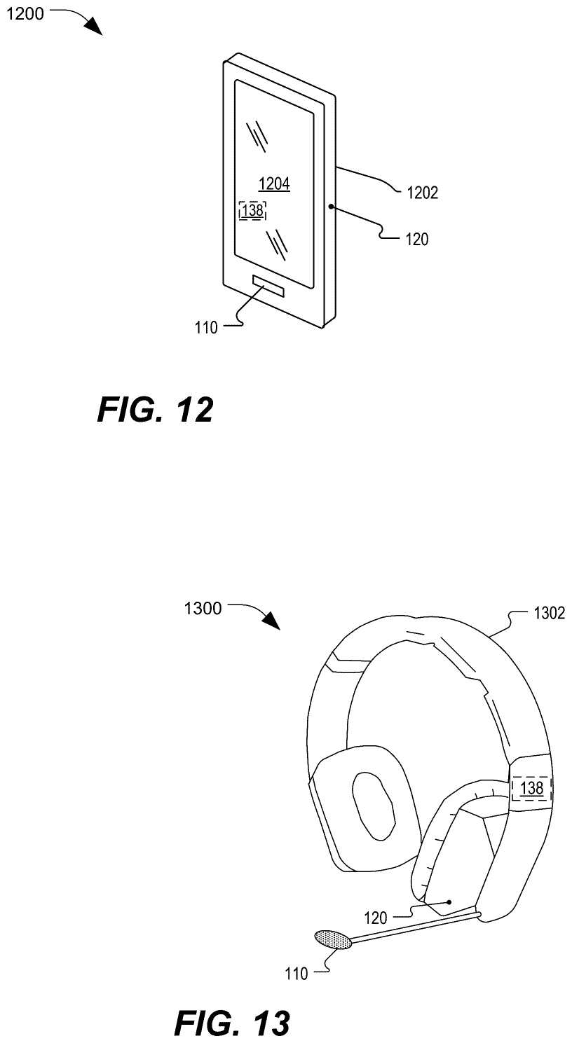

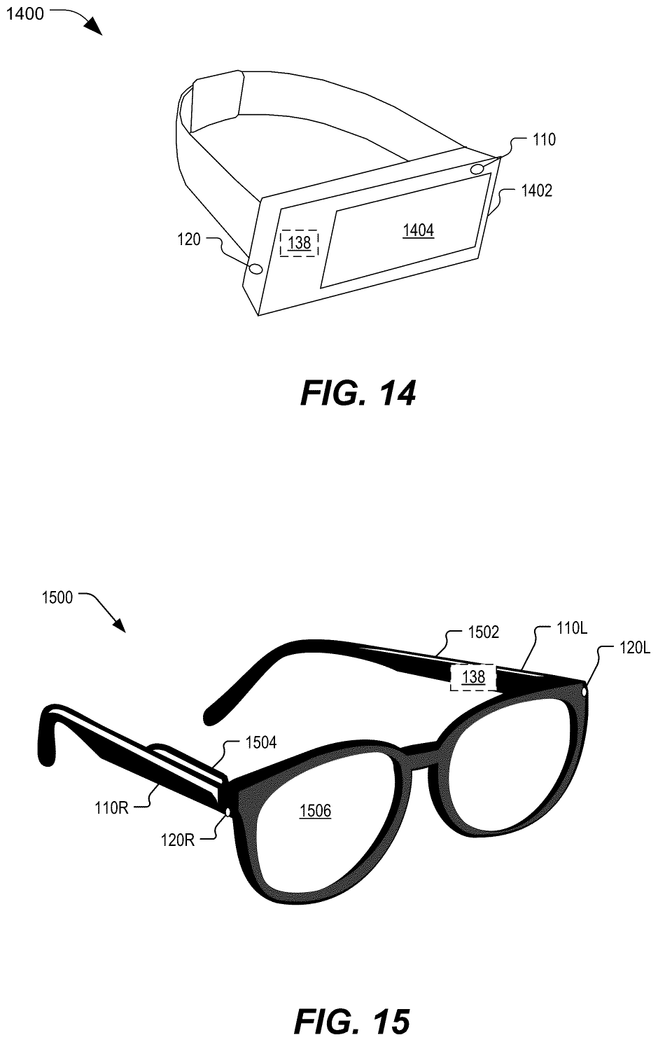

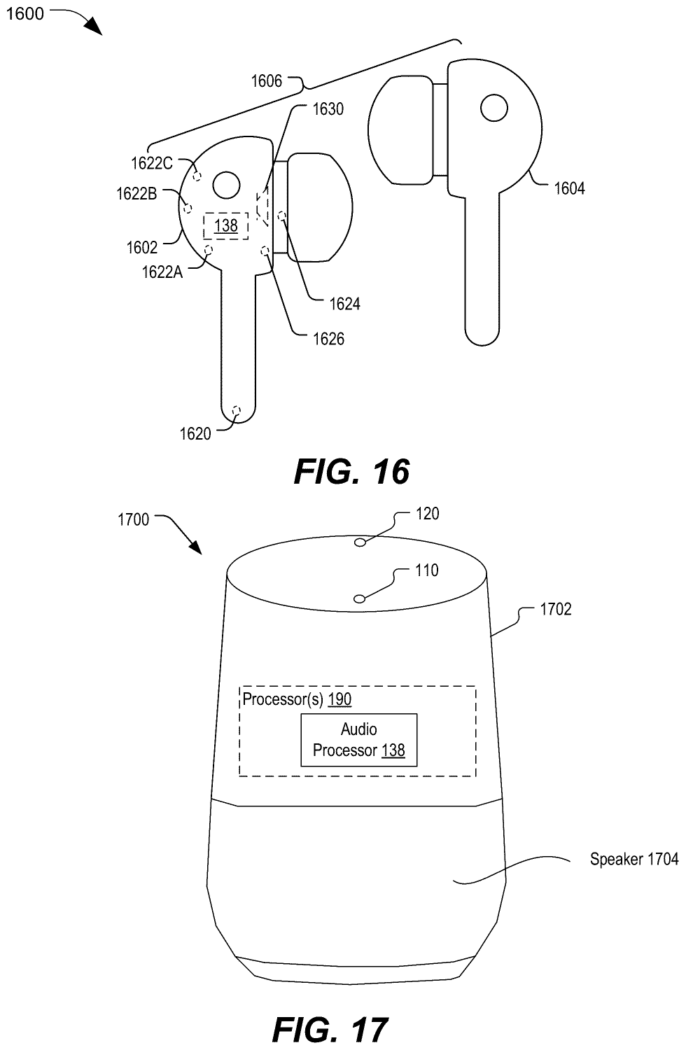

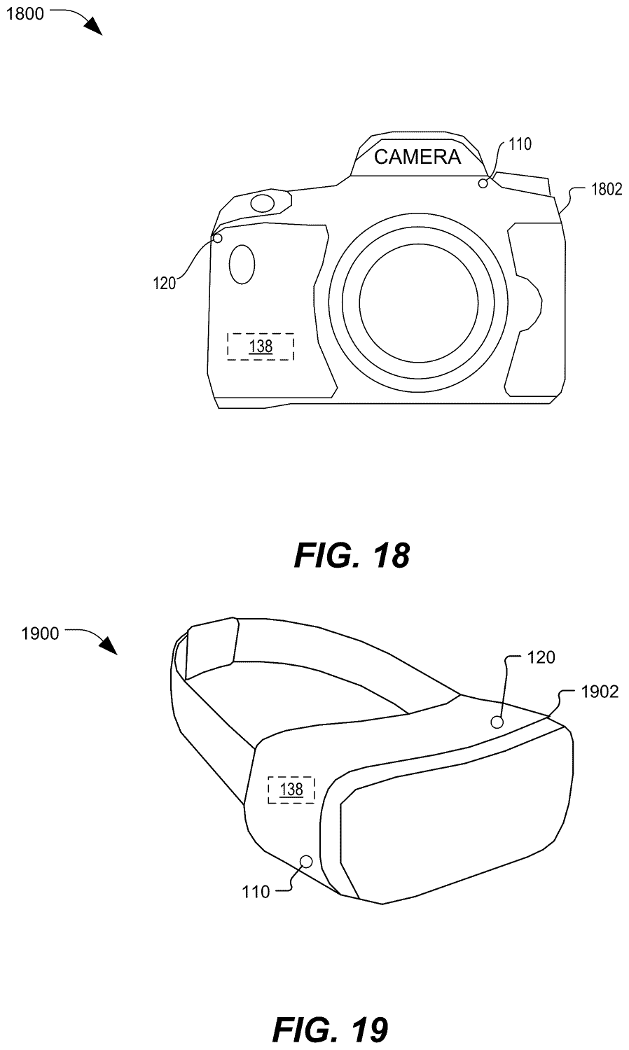

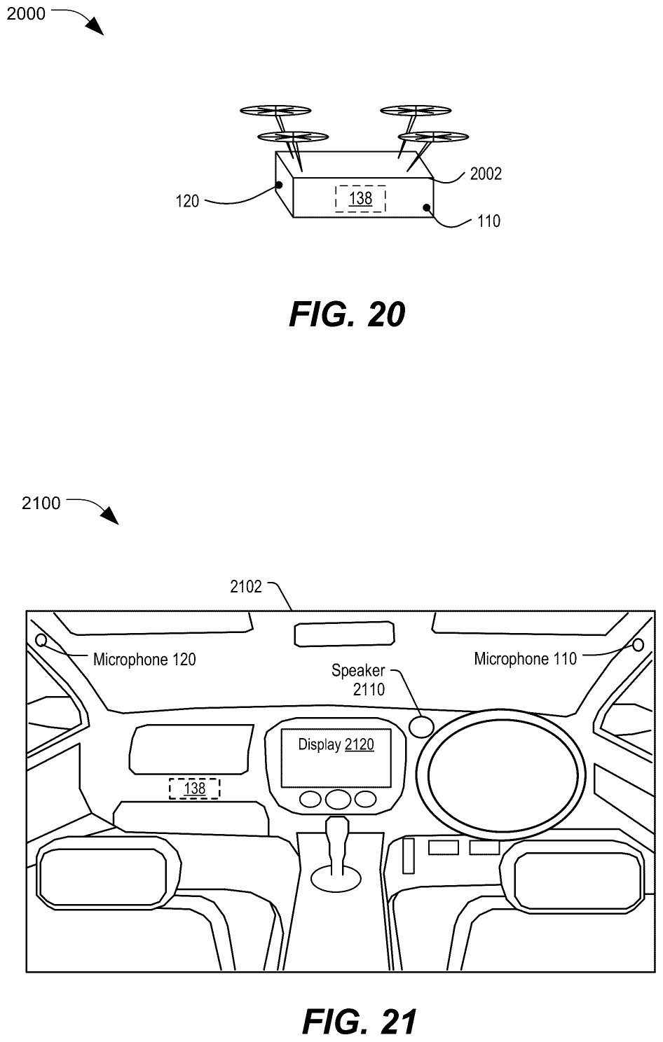

In a particular embodiment, the device 102 corresponds to or is included in one of various types of devices. In an illustrative example, the one or more processors 190 are integrated in a headset device that includes the microphone 110 and the microphone 120, such as described further with reference to FIG. 13. In other examples, the one or more processors 190 are integrated in at least one of a mobile phone or a tablet computer device, as described with reference to FIG. 12, a wearable electronic device, as described with reference to FIG. 14, augmented reality or mixed reality glasses, as described with reference to FIG. 15, a set of in-ear devices, as described with reference to FIG. 16, a voice-controlled speaker system, as described with reference to FIG. 17, a camera device, as described with reference to FIG. 18, or a virtual reality, mixed reality, or augmented reality headset, as described with reference to FIG. 19. In another illustrative example, the one or more processors 190 are integrated into a vehicle that also includes the microphone 110 and the microphone 120, such as described further with reference to FIG. 20 and FIG. 21.

During operation, the audio processor 138 receives audio data from one or more microphones. The one or more microphones are configured to capture various sounds of an audio environment. For example, the input interface 114 receives microphone output 112 from the microphone 110 and provides the microphone output 112 as audio data 116 to the audio processor 138. As another example, the input interface 124 receives microphone output 122 from the microphone 120 and provides the microphone output 122 as audio data 126 to the audio processor 138.

In an illustrative example, the microphone 110 is configured to capture first sounds (e.g., speech 182) from a sound source 180 (e.g., a person) of an audio environment to generate the microphone output 112 and the microphone 120 is configured to capture second sounds (e.g., ambient sound 186, such as a musical instrument, car sounds, etc.) from a sound source 184A (e.g., a musical instrument), a sound source 184B (e.g., a car), one or more additional sound sources, or a combination thereof, of the audio environment to generate the microphone output 122. In some cases, the microphone output 112 can also represent at least some of the ambient sound 186, the microphone output 122 can also represent at least some of the speech 182, or a combination thereof.

The audio processor 138 provides audio data to the audio enhancer 134. For example, the audio processor 138 generates audio data 117 based on the audio data 116 and provides the audio data 117 to the audio enhancer 134. In a particular embodiment, the audio data 117 is a copy of the audio data 116. In another optional embodiment, the audio processor 138 performs one or more pre-processing operations on the audio data 116 to generate the audio data 117 and provides the audio data 117 to the audio enhancer 134. Similarly, as another example, the audio processor 138 generates the audio data 127 based on the audio data 126, and provides the audio data 127 to the audio enhancer 134.

The audio frequency splitter 142 obtains audio data corresponding to a frequency band and processes the audio data to generate subband audio data corresponding to respective subbands of the frequency band. For example, the audio frequency splitter 142 obtains the audio data 117 corresponding to a frequency band (e.g., 0-16 kHz) and generates subband audio data 118A corresponding to a first frequency subband, subband audio data 118B corresponding to a second frequency subband, subband audio data 118C corresponding to a third frequency subband, one or more additional sets of subband audio corresponding to respective frequency subbands, or a combination thereof.

In another example, the audio frequency splitter 142 obtains the audio data 127 corresponding to the frequency band (e.g., 0-16 kHz) and generates subband audio data 128A corresponding to the first frequency subband, subband audio data 1d8B corresponding to the second frequency subband, subband audio data 128C corresponding to the third frequency subband, one or more additional sets of subband audio corresponding to respective frequency subbands, or a combination thereof.

According to an optional embodiment, at least two of the frequency subbands are adjacent. In an example, the first frequency subband (e.g., 0-8 kHz) is adjacent to the second frequency subband (e.g., 8-12 kHz). According to an optional embodiment, at least two of the frequency subbands are overlapping. In an example, the second frequency subband (e.g., 8-12 kHz) overlaps the third frequency subband (e.g., 11 kHz-16 kHz).

The enhanced subband audio generator 140 provides audio data corresponding to a particular subband to a corresponding audio subband enhancer 144. For example, the enhanced subband audio generator 140 provides the subband audio data 118A, the subband audio data 128A, or both, to the audio subband enhancer 144A associated with the first frequency subband. As another example, the enhanced subband audio generator 140 provides the subband audio data 118B, the subband audio data 128B, or both, to the audio subband enhancer 144B associated with the second frequency subband. As yet another example, the enhanced subband audio generator 140 provides the subband audio data 118C, the subband audio data 128C, or both, to the audio subband enhancer 144C.

The audio subband enhancer 144A processes the subband audio data 118A, the subband audio data 128A, or both, to generate enhanced subband audio data 136A corresponding to the first frequency subband. According to an optional embodiment, the enhanced subband audio data 136A corresponds to a noise suppressed version, an echo canceled version, or both, of the subband audio data 118A, the subband audio data 128A, or both. For example, the enhanced subband audio data 136A represents noise-suppressed audio, echo canceled audio, or both.

Similarly, the audio subband enhancer 144B processes the subband audio data 118B, the subband audio data 128B, or both, to generate enhanced subband audio data 136B corresponding to the second frequency subband. As another example, the audio subband enhancer 144C processes the subband audio data 118C, the subband audio data 128C, or both, to generate enhanced subband audio data 136C corresponding to the third frequency band.

In a particular embodiment, at least one of the audio subband enhancers 144 includes a machine-learning model. In an example, the audio subband enhancer 144A includes a first machine-learning model, and the audio subband enhancer 144A uses the first machine-learning model to process the subband audio data 118A, the subband audio data 128A, or both, to generate the enhanced subband audio data 136A. In another example, the audio subband enhancer 144B includes a second machine-learning model, and the audio subband enhancer 144B uses the second machine-learning model to process the subband audio data 118B, the subband audio data 128B, or both, to generate the enhanced subband audio data 136B. In yet another example, the audio subband enhancer 144C includes a third machine-learning model, and the audio subband enhancer 144C uses the third machine-learning model to process the subband audio data 118C, the subband audio data 128C, or both, to generate the enhanced subband audio data 136C.

Each of the machine-learning models included in the audio subband enhancers 144 can be trained independently to enhance audio data of a corresponding frequency subband. For example, the first machine-learning model is trained to enhance audio data corresponding to the first frequency subband. As another example, the second machine-learning model is trained to enhance audio data corresponding to the second frequency subband. As yet another example, the third machine-learning model is trained to enhance audio data corresponding to the third frequency subband.

Each machine-learning model has particular model weights and a particular model architecture. For example, the first machine-learning model has first model weights and a first model architecture. As another example, the second machine-learning model has second model weights and a second model architecture. As yet another example, the third machine-learning model has third model weights and a third model architecture.

In a particular embodiment, the first model weights are distinct from the second model weights, the third model weights, or a combination thereof. In a particular embodiment, the second model weights are distinct from the third model weights. In a particular embodiment, the first model architecture is distinct from the second model architecture, the third model architecture, or both. In a particular embodiment, the second model architecture is distinct from the third model architecture. A model architecture includes a count of layers, a count of nodes, a node type, a layer type, or a combination thereof. In a particular embodiment, at least one of the first model architecture, the second model architecture, or the third model architecture includes a long short-term memory network (LSTM), and at least another one of the first model architecture, the second model architecture, or the third model architecture includes a convolutional neural network.

In a particular optional embodiment, at least one of the audio subband enhancers 144 uses procedural signal processing to process subband audio data to generate enhanced subband audio. In an example, the audio subband enhancer 144A uses first procedural signal processing, in addition to or as an alternative to the first machine-learning model, to process the subband audio data 118A, the subband audio data 128A, or both, to generate the enhanced subband audio data 136A. In another example, the audio subband enhancer 144B uses second procedural signal processing, in addition to or as an alternative to the second machine-learning model, to process the subband audio data 118B, the subband audio data 128B, or both, to generate the enhanced subband audio data 136B. As yet another example, the audio subband enhancer 144C uses third procedural signal processing, in addition to or as an alternative to the third machine-learning model, to process the subband audio data 118C, the subband audio data 128C, or both, to generate the enhanced subband audio data 136C. In some aspects, procedural signal processing can include using filters to enhance (e.g., apply echo cancellation, noise suppression, or both to) audio.

The combiner 148 combines the enhanced subband audio data 136A, the enhanced subband audio data 136B, the enhanced subband audio data 136C, one or more additional sets of enhanced subband audio data, or a combination thereof, to generate enhanced audio data 135. In a particular aspect, the enhanced audio data 135 represents the same frequency band (e.g., 0-16 kHz) as the audio data 117, the audio data 127, or both.

The audio processor 138 generates an output 146 based on the enhanced audio data 135. In some embodiments, the output 146 is a copy of the enhanced audio data 135. According to an optional embodiment, the audio processor 138 provides the output 146 to one or more speakers, one or more components, one or more other devices, or a combination thereof. According to an optional embodiment, the audio processor 138 performs speech recognition on the enhanced audio data 135 and generates the output 146 based on the recognized speech. In some examples, the output 146 corresponds to text representing the recognized speech. In some examples, the output 146 corresponds to a command to initiate one or more operations based on the recognized speech.

The system 100 thus performs subband enhancement to generate enhanced subband audio data that can be combined to generate enhanced audio data corresponding to a frequency band. A technical advantage of performing subband enhancement can include that the audio subband enhancers 144 that are trained to enhance a respective subband can be less complex and more efficient than a single audio enhancer that processes the entire frequency band.

In some optional embodiments, the enhanced subband audio generator 140 can drop some of the subbands of the frequency band. For example, the enhanced subband audio generator 140 refrains from providing a subset of the subband audio data generated by the audio frequency splitter 142 to the audio subband enhancers 144. To illustrate, the enhanced subband audio generator 140 refrains from providing the subband audio data 118C, the subband audio data 128C, or both, to the audio subband enhancer 144C. In some aspects, the audio subband enhancer 144C is not included (or is disabled) in the audio subband enhancers 144. The audio subband enhancer 144 generates the enhanced audio data 135 based on the enhanced subband audio data 136A, the enhanced subband audio data 136B, or both. In these embodiments, the enhanced audio data 135 represents a frequency band that is a subset of the frequency band represented by the audio data 117, the audio data 127, or both.

In some optional embodiments, the enhanced subband audio generator 140 can bypass the audio subband enhancers 144 for one or more subbands. For example, the enhanced subband audio generator 140 provides the subband audio data 118C, the subband audio data 128C, or both, to the combiner 148. To illustrate, the enhanced subband audio generator 140 can provide a weighted combination of the subband audio data 118C and the subband audio data 128C as representing the third frequency subband to the combiner 148.

The combiner 148 combines the subband audio data with other subband audio data corresponding to respective subbands to generate the enhanced audio data 135. In a particular example, the combiner 148 combines the subband audio data 118C with the enhanced subband audio data 136A, the enhanced subband audio data 136B, or both, to generate the enhanced audio data 135. In another example, the combiner 148 combines the subband audio data 128C with the enhanced subband audio data 136A, the enhanced subband audio data 136B, or both, to generate the enhanced audio data 135. In yet another example, the combiner 148 combines a weighted combination of the subband audio data 118C and the subband audio data 128C with the enhanced subband audio data 136A, the enhanced subband audio data 136B, or both, to generate the enhanced audio data 135.

Although the microphone 110 and the microphone 120 are illustrated as being coupled to the device 102, in other optional embodiments one or both of the microphone 110 or the microphone 120 may be integrated in the device 102. Although the two microphones 110, 120 are illustrated, in other optional embodiments one or more additional microphones configured to capture user speech, one or more microphones configured to capture environmental sounds, or both, may be included. Although the device 102 is illustrated as including all of the components of the audio enhancer 134, in other optional embodiments at least one component of the audio enhancer 134 may be included in another device, and data may be exchanged between the device 102 and the other device.

It should be understood that two microphones and three subbands are provided as an illustrative example. In other optional examples, the audio processor 138 can receive audio data from fewer than two or more than two microphones, and the audio frequency splitter 142 can split audio data into fewer than three or more than three subbands. Although the audio processor 138 is illustrated as processing audio data received from microphones 110, 120, in other optional embodiments the audio processor 138 can process audio data that is retrieved from a storage device, generated by a component of the device 102, received from another device, or a combination thereof.

In some optional embodiments, the microphone 110 can correspond to a near-end microphone and the audio data 117 corresponds to near end audio. In some optional embodiments, the audio data 127 corresponds to reference audio data representing far end audio. In an illustrative example, the audio data 127 is received at the device 102 from a second device during a call (e.g., a conference call) with the second device. When the audio data 127 is played out by a speaker of the device 102, the microphone 110 can also capture some of the far end audio that is played out by the speaker. The audio subband enhancers 144 can enhance (e.g., reduce echo in) the audio captured by the microphone 110 to retain the near end audio and reduce (e.g., remove) the far end audio. For example, the audio subband enhancer 144A processes the subband audio data 118A based on the subband audio data 128A to generate the enhanced subband audio data 136A.

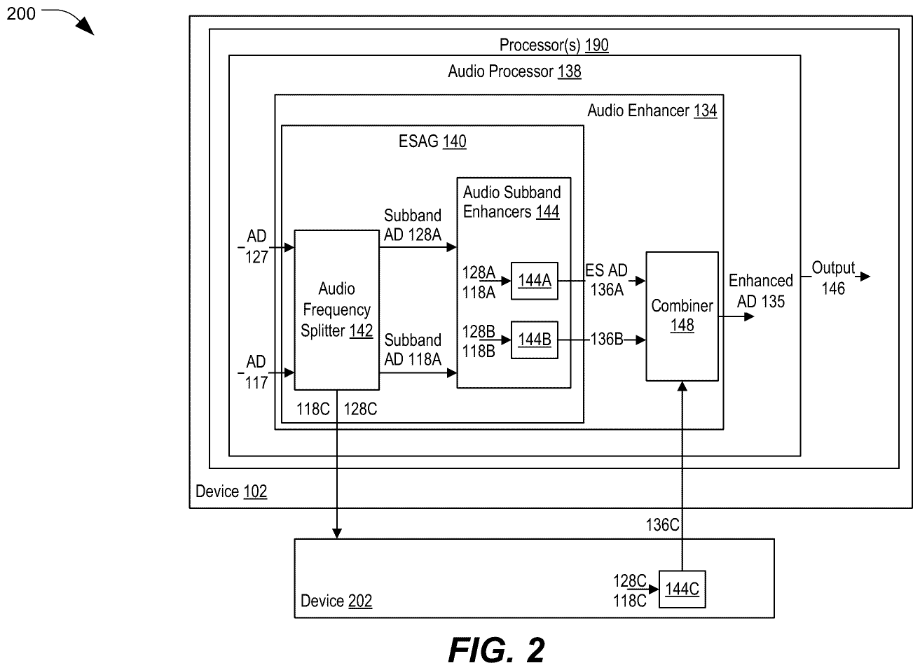

Referring to FIG. 2, a diagram is shown of an illustrative aspect of a system 200 that is operable to perform machine-learning based audio subband processing. In a particular aspect, the system 100 of FIG. 1 includes one or more components of the system 200.

The system 200 includes a device 202 coupled to the device 102. The device 102 can offload at least some of the processing of the audio processor 138, described with reference to FIG. 1, to the device 202. In some optional embodiments, the device 202 is a network device. In some optional embodiments, one of the device 102 or the device 202 is a headset device, and the other of the device 102 or the device 202 is a user device.

In some optional embodiments, the audio enhancer 134 can send subband audio data corresponding to one or more subbands to the device 202 to generate corresponding enhanced subband audio data. For example, the audio enhancer 134 sends the subband audio data 118C, the subband audio data 128C, or both, corresponding to the third frequency subband to the device 202.

The device 202 includes one or more audio subband enhancers 144. For example, the device 202 includes the audio subband enhancer 144C that is configured to process subband audio data (e.g., the subband audio data 118C, the subband audio data 128C, or a combination thereof) corresponding to the third frequency subband to generate enhanced subband audio data 136C corresponding to the third frequency subband. The device 202 provides the enhanced subband audio data 136C to the audio enhancer 134.

The audio enhancer 134 receives the enhanced subband audio data 136C from the device 202 and provides the enhanced subband audio data 136C to the combiner 148. The combiner 148 combines the enhanced subband audio data 136A, the enhanced subband audio data 136B, the enhanced subband audio data 136C, one or more additional sets of subband audio data, or a combination thereof, to generate the enhanced audio data 135.

A technical advantage of the system 200 can thus include distributed subband enhancement. The audio enhancer 134 can use resources (e.g., memory, computation cycles, or both) of multiple devices, such as the device 102, the device 202, one or more additional devices, or a combination thereof to generate the enhanced audio data 135.

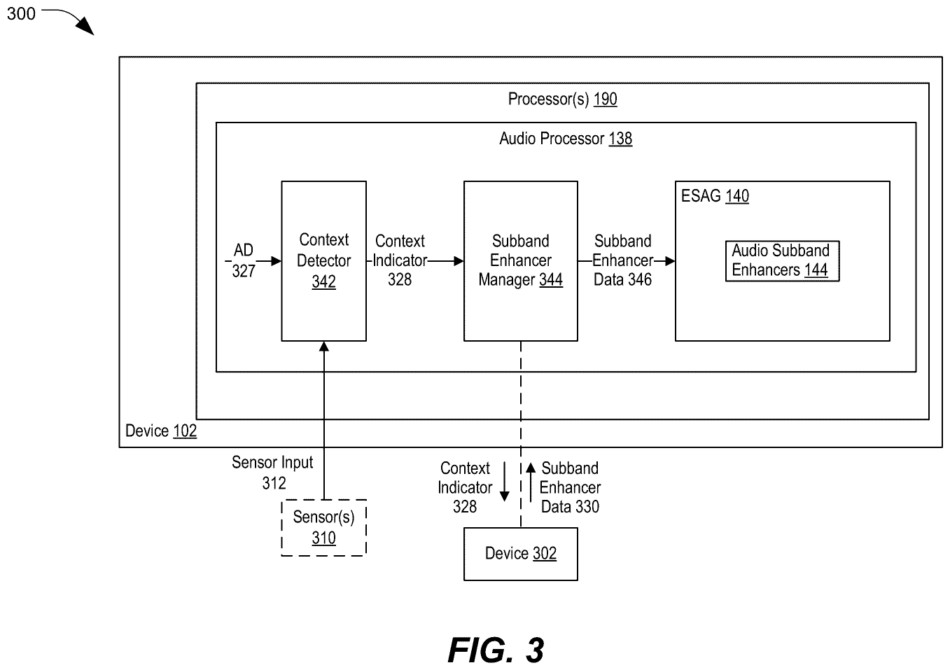

Referring to FIG. 3, a diagram is shown of an illustrative aspect of a system 300 that is operable to perform machine-learning based audio subband processing. In a particular aspect, the system 100 of FIG. 1 can include one or more components of the system 300.

The audio processor 138 includes a context detector 342 coupled via a subband enhancer manager 344 to the enhanced subband audio generator 140. In some optional embodiments, the context detector 342 is also coupled to one or more sensors 310. The one or more sensors 310 can include a gyroscope, a camera, a microphone, or a combination thereof. In some optional embodiments, the subband enhancer manager 344 is coupled to a device 302.

The context detector 342 receives sensor input 312 from the one or more sensors 310. In a particular embodiment, the sensor input 312 indicates a device orientation of the device 102, a detected sound source, a detected occlusion, or a combination thereof. In an example, the device 102 includes a phone and the sensor input 312 indicates a phone orientation. The context detector 342 generates a context indicator 328 based on audio data 327, the sensor input 312, or a combination thereof. The audio data 327 is based on the audio data 116, the audio data 126, the audio data 117, the audio data 127, audio data from one or more additional microphones, or a combination thereof.

The context indicator 328 indicates a detected context of the audio environment. In a particular aspect, the context indicator 328 indicates a location type (e.g., indoors, outdoors, library, concert, in an airplane, in a car, in a park, near a busy road, at the beach, etc.) of the audio environment. In a particular aspect, the context indicator 328 indicates sound source types (e.g., a person, a musical instrument, a car, traffic, crowds, trees, ocean, etc.) detected in the audio environment. In a particular aspect, the context indicator 328 indicates that a particular occlusion is detected at a particular location in the audio environment.

The subband enhancer manager 344 obtains the context indicator 328 indicating a detected context of the audio environment and provides subband enhancer data 346 to the enhanced subband audio generator 140. For example, the subband enhancer manager 344 configures the enhanced subband audio generator 140 based on the subband enhancer data 346. According to some optional embodiments, the subband enhancer manager 344 provides the context indicator 328 to the device 302, receives subband enhancer data 330 from the device 302, and generates the subband enhancer data 346 based on the subband enhancer data 330.

In a particular aspect, the subband enhancer data 346 indicates a selection of one or more machine-learning models to be used as the audio subband enhancers 144. In a particular aspect, the subband enhancer data 346 indicates selection of one or more model parameters to be used by the audio subband enhancers 144. For example, the subband enhancer data 346 indicates that a first machine-learning model with first model parameters is to be used as the audio subband enhancer 144A to process audio data associated with the first frequency subband. As another example, the subband enhancer data 346 indicates that a second machine-learning model with second model parameters is to be used as the audio subband enhancer 144B to process audio data associated with the second frequency subband. As yet another example, the subband enhancer data 346 indicates that procedural signal processing is to be performed by the audio subband enhancer 144C on audio data associated with the third frequency subband. In some illustrative examples, the subband enhancer data 346 can indicate one or more frequency subbands that are to be dropped, one or more frequency subbands that are to bypass the audio subband enhancers 144, or a combination thereof.

A technical advantage of the system 300 can include dynamically selecting and adjusting the audio subband enhancers 144 based on a detected context of an audio environment. The device 302 can also provide updates to the device 102 of machine-learning models, procedural signal processing, model parameters, or a combination thereof, that are associated with various audio contexts. In a particular embodiment, the device 302 can be a central repository of models and model parameters associated with various contexts that can be accessed by multiple devices 102.

It should be understood that the subband enhancer manager 344 obtaining the subband enhancer data 330 from a single device 302 is provided as an illustrative example. In other examples, the subband enhancer manager 344 can obtain versions of the subband enhancer data 330 from multiple devices 302 to generate the subband enhancer data 346. In an illustrative example, the subband enhancer manager 344 sends the context indicator 328 to a first device 302 and receives first subband enhancer data 330 corresponding to the audio subband enhancer 144A (e.g., a LSTM-based model). Similarly, the subband enhancer manager 344 sends the context indicator 328 to a second device 302 and receives second subband enhancer data 330 corresponding to the audio subband enhancer 144B (e.g., a convolutional model). The subband enhancer manager 344 generates the subband enhancer data 346 based on the first subband enhancer data 330 and the second subband enhancer data 330.

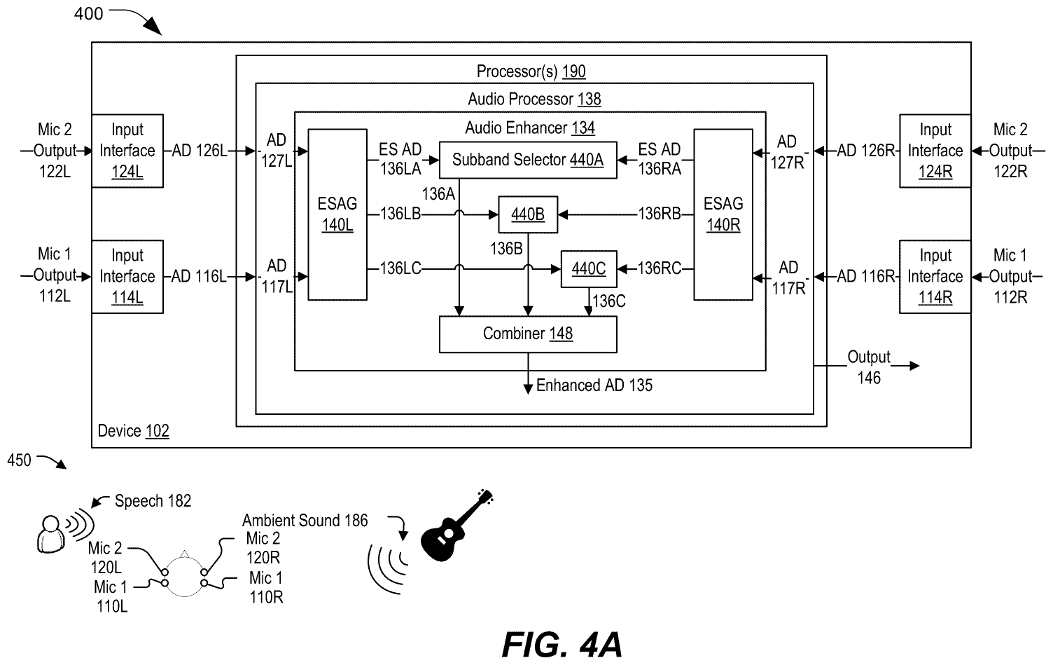

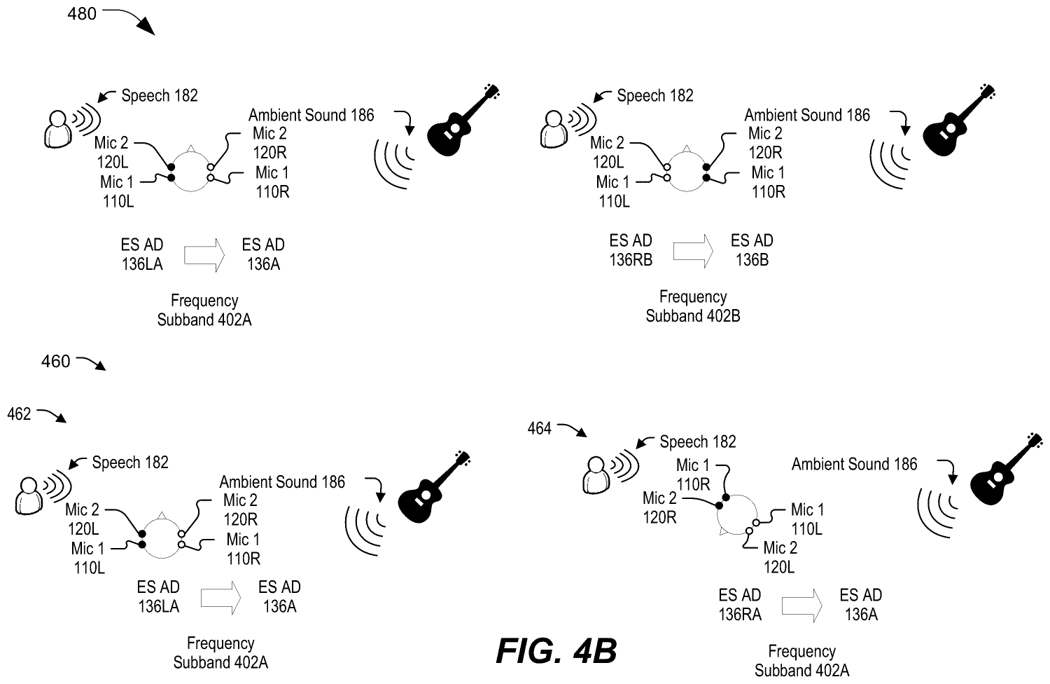

Referring to FIG. 4A, a diagram is shown of an illustrative aspect of a system 400 that is operable to perform machine-learning based audio subband processing. In a particular aspect, the system 100 of FIG. 1 can include one or more components of the system 400. The device 102 includes or is coupled to multiple microphones (e.g., a microphone array).

In an example 450, the device 102 includes or is coupled to two left microphones (e.g., a microphone 110L and a microphone 120L) and two right microphones (e.g., a microphone 110R and a microphone 120R). The device 102 includes an input interface 114L, an input interface 124L, an input interface 114R, and an input interface 124R that are configured to be coupled to the microphone 110L, the microphone 120L, the microphone 110R, and the microphone 120R, respectively.

The input interface 114L provides microphone output 112L from the microphone 110L as audio data 116L to the audio processor 138. The input interface 124L provides microphone output 122L from the microphone 120L as audio data 126L to the audio processor 138. The input interface 114R provides microphone output 112R from the microphone 110R as audio data 116R to the audio processor 138. The input interface 124R provides microphone output 122R from the microphone 120R as audio data 126R to the audio processor 138.

In a particular embodiment, the device 102 includes an enhanced subband audio generator 140L and an enhanced subband audio generator 140R. The audio processor 138 generates audio data 117L based on the audio data 116L and generates the audio data 127L based on the audio data 126L. For example, the audio processor 138 can perform one or more pre-processing operations on the audio data 116L to generate the audio data 117L and perform one or more pre-processing operations on the audio data 126L to generate the audio data 127L. Similarly, the audio processor 138 generates audio data 117R based on the audio data 116R and generates the audio data 127R based on the audio data 126R.

The audio processor 138 provides the audio data 117L and the audio data 127L to the enhanced subband audio generator 140L. The enhanced subband audio generator 140L performs one or more operations described with reference to the enhanced subband audio generator 140 of FIG. 1 to process the audio data 117L, the audio data 127L, audio data from one or more additional microphones, or a combination thereof, to generate enhanced subband audio data 136LA associated with a first frequency subband, enhanced subband audio data 136LB associated with a second frequency subband, enhanced subband audio data 136LC associated with a third frequency subband, one or more additional sets of enhanced subband audio data, or a combination thereof.

The audio processor 138 provides the audio data 117R and the audio data 127R to the enhanced subband audio generator 140R. The enhanced subband audio generator 140R performs one or more operations described with reference to the enhanced subband audio generator 140 of FIG. 1 to process the audio data 117R, the audio data 127R, audio data from one or more additional microphones, or a combination thereof, to generate enhanced subband audio data 136RA associated with the first frequency subband, enhanced subband audio data 136RB associated with the second frequency subband, enhanced subband audio data 136RC associated with the third frequency subband, one or more additional sets of enhanced subband audio data, or a combination thereof.

The audio enhancer 134 provides enhanced subband audio data to subband selectors corresponding to the same subband. For example, the audio enhancer 134 provides the enhanced subband audio data 136LA and the enhanced subband audio data 136RA to a subband selector 440A that is associated with the first frequency subband. As another example, the audio enhancer 134 provides the enhanced subband audio data 136LB and the enhanced subband audio data 136RB to a subband selector 440B that is associated with the second frequency subband. As yet another example, the audio enhancer 134 provides the enhanced subband audio data 136LC and the enhanced subband audio data 136RC to a subband selector 440C that is associated with the third frequency subband.

In a particular optional embodiment, a subband selector 440 selects one set of enhanced subband audio data to output as a selected enhanced subband audio data associated with a corresponding frequency subband. In an example, the subband selector 440A generates a first sound metric of the enhanced subband audio data 136LA and a second sound metric of the enhanced subband audio data 136RA. In a particular aspect, a sound metric includes a signal-to-noise ratio (SNR). In a particular aspect, a sound metric includes a speech quality metric, a speech intelligibility metric, or both. The subband selector 440A selects one of the enhanced subband audio data 136LA or the enhanced subband audio data 136RA based on a comparison of the first sound metric and the second sound metric. For example, the subband selector 440A, in response to determining that the first sound metric is greater than the second sound metric, selects the enhanced subband audio data 136LA to output as the enhanced subband audio data 136A.

In a particular optional embodiment, a subband selector 440 generates enhanced subband audio data as a weighted combination of sets of enhanced subband audio data associated with the same frequency subband. For example, the subband selector 440A generates a weighted combination of the enhanced subband audio data 136LA and the enhanced subband audio data 136RA as the enhanced subband audio data 136A.

Similarly, the subband selector 440B outputs the enhanced subband audio data 136B based on the enhanced subband audio data 136LB and the enhanced subband audio data 136RB. As another example, the subband selector 440C outputs the enhanced subband audio data 136C based on the enhanced subband audio data 136LC and the enhanced subband audio data 136RC. The combiner 148 generates the enhanced audio data 135 based on the enhanced subband audio data 136A, the enhanced subband audio data 136B, the enhanced subband audio data 136C, or a combination thereof, as described with reference to FIG. 1.

Referring to FIG. 4B, a diagram is shown of examples of an illustrative aspect of operation of components of the system 400 of FIG. 4A. In an example 480, the subband selector 440A of FIG. 4A. selects the enhanced subband audio data 136A as the enhanced subband audio data 136A of a frequency subband 402A. In this example, the subband selector 440B of FIG. 4A selects the enhanced subband audio data 136RB as the enhanced subband audio data 136B of a frequency subband 402B.

The audio enhancer 134 can thus use audio data from different microphones for different subbands. For example, the frequency subband 402A can correspond to speech and the enhanced audio data 135 can include the enhanced subband audio data 136LA that is based on audio data from the microphone 110L and the microphone 120L that are closer to a speech source. As another example, the frequency subband 402B can correspond to music and the enhanced audio data 135 can include the enhanced subband audio data 136RB that is based on audio data from the microphone 110R and the microphone 120R that are closer to a music source.

In an example 460, at a time 462, the subband selector 440A of FIG. 4A selects the enhanced subband audio data 136LA as the enhanced subband audio data 136A of the frequency subband 402A. In this example, at a time 464, the subband selector 440A selects the enhanced subband audio data 136RA as the enhanced subband audio data 136A of the frequency subband 402A.

The audio enhancer 134 can thus select subband audio data from different microphones at different times as sound sources move relative to the microphones, as the audio quality of the captured sounds changes, or a combination thereof. A technical advantage of the subband selectors 440 can include dynamically selecting source audio based on subband audio quality.

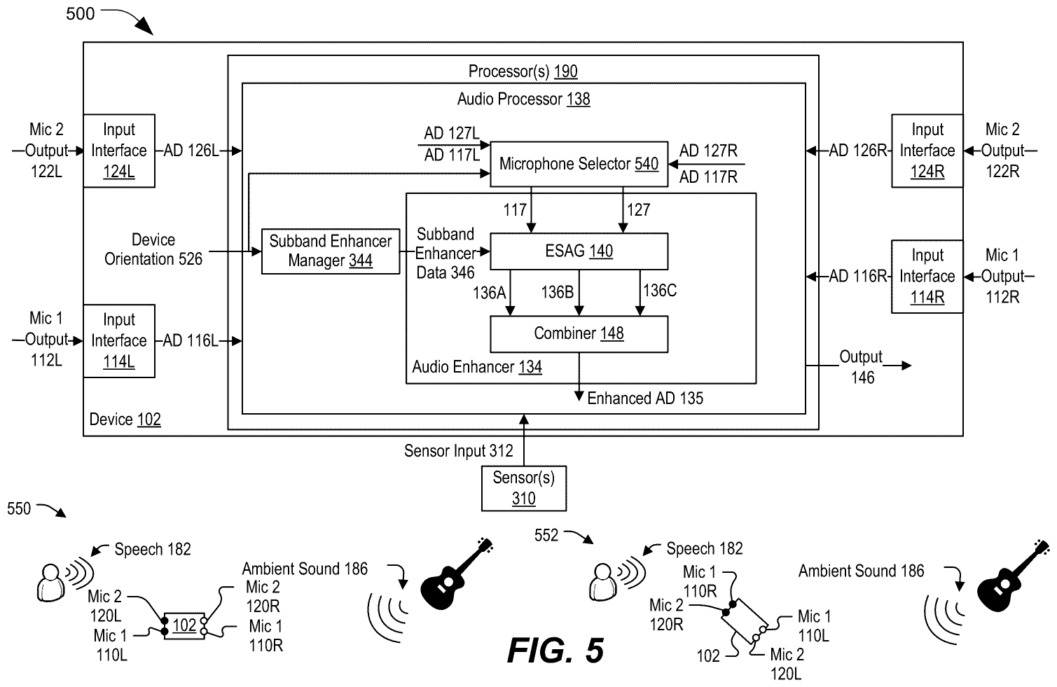

Referring to FIG. 5, a diagram is shown of an illustrative aspect of a system 500 that is operable to perform machine-learning based audio subband processing. In a particular aspect, the system 100 of FIG. 1 can include one or more components of the system 500.

The audio processor 138 includes a microphone selector 540 that is configured to select one or more microphones based on a device orientation 526 of the device 102. In an example, the audio processor 138 has access to microphone location data indicating locations of the microphones on the device 102. For example, the microphone location data indicates that the microphone 120R is located at a front-right of the device 102, that the microphone 110R is located at a back-right of the device 102, that the microphone 120L is located at a front-left of the device 102, that the microphone 110L is located at a back-left of the device 102.

The audio processor 138 determines a target source location based on a user input, sound source recognition, default data, a configuration setting, or a combination thereof. In an example 550, the microphone selector 540 determines, based on the device orientation 526 at a first time, that the target source location is left of the device 102 at the first time. The microphone selector 540 selects one or more microphones that correspond to the target source location relative to the device 102. For example, the microphone selector 540, in response to determining that the target source location is left of the device 102, selects the microphone 120L and the microphone 110L that are located on the left of the device 102. The microphone selector 540 provides the audio data 117L as the audio data 117 to the enhanced subband audio generator 140 and provides the audio data 127L as the audio data 127 to the enhanced subband audio generator 140.

In an example 552, the microphone selector 540 determines, based on the device orientation 526 at a second time, that the target source location is on the right relative to the device 102 at the second time. The microphone selector 540 selects one or more microphones that correspond to the target source location relative to the device 102. For example, the microphone selector 540, in response to determining that the target source location is right of the device 102, selects the microphone 120R and the microphone 110R that are located on the right of the device 102. The microphone selector 540 provides the audio data 117R as the audio data 117 to the enhanced subband audio generator 140 and provides the audio data 127R as the audio data 127 to the enhanced subband audio generator 140.

In a particular optional embodiment, the subband enhancer manager 344 generates the subband enhancer data 346 based on the device orientation 526 and configures the enhanced subband audio generator 140 based on the subband enhancer data 346, as described with reference to FIG. 3.

The enhanced subband audio generator 140 processes audio data (e.g., the audio data 117 and the audio data 127) from the selected microphones to generate the enhanced subband audio data 136A, the enhanced subband audio data 136B, the enhanced subband audio data 136C, enhanced subband audio data of one or more additional audio subbands, or a combination thereof, as described with reference to FIG. 1. A technical advantage of the microphone selector 540 can include conserving resources by refraining from processing audio data from microphones that are further away from a target sound source.

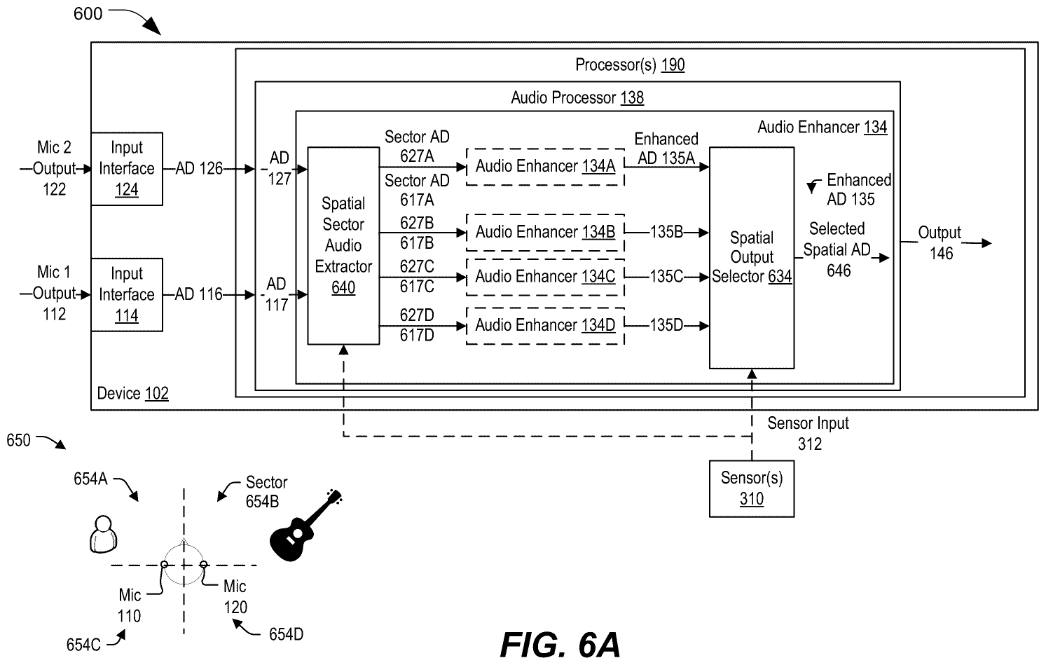

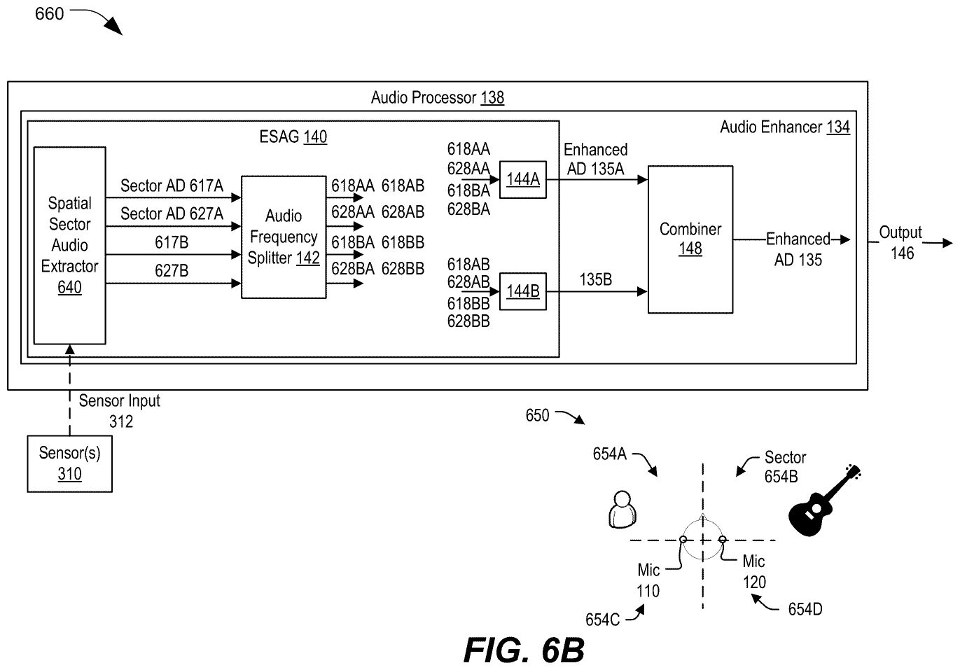

Referring to FIG. 6A, a diagram is shown of an illustrative aspect of a system 600 operable to perform machine-learning based audio subband processing. In a particular aspect, the system 100 of FIG. 1 can include one or more components of the system 600.

The audio enhancer 134 includes a spatial sector audio extractor 640 that is configured to extract spatial sector audio data. In a particular aspect, the spatial sector audio extractor 640 includes one or more machine-learning models. In an example 650, an audio scene is logically divided into a sector 654A, a sector 654B, a sector 654C, and a sector 654D. The audio scene including four spatial sectors is provided as an illustrative example, in other examples an audio scene can include fewer than four or more than four spatial sectors. According to some embodiments, the audio scene corresponds to a three dimensional space and spatial sectors correspond to portions of the three dimensional space. It should be understood that the audio scene including non-overlapping sectors is provided as an illustrative example, in other examples two or more spatial sectors can overlap.

The audio enhancer 134 processes audio data representing an audio scene to generate sets of sector audio data associated with sectors of the audio scene. For example, the spatial sector audio extractor 640 processes the audio data 117 to generate sector audio data 617A, sector audio data 617B, sector audio data 617C, and sector audio data 617D corresponding to the sector 654A, the sector 654B, the sector 654C, and the sector 654D, respectively. As another example, the spatial sector audio extractor 640 processes the audio data 127 to generate sector audio data 627A, sector audio data 627B, sector audio data 627C, and sector audio data 627D, respectively.

In a particular optional embodiment, the spatial sector audio extractor 640 includes machine-learning models that are associated with respective sectors. For example, the spatial sector audio extractor 640 uses each of a first machine-learning model, a second machine-learning model, a third machine-learning model, and a fourth machine-learning model to process the audio data 117 to generate the sector audio data 617A, the sector audio data 617B, the sector audio data 617C, and the sector audio data 617D, respectively. In a particular optional embodiment, the spatial sector audio extractor 640 includes one or more machine-learning models corresponding to at least one of a generative network, a speech generative network (SGN), a LSTM, or a convolutional network.

In a particular optional embodiment, the audio processor 138 performs subband audio enhancement for one or more spatial sectors. For example, the audio processor 138 provides the sector audio data 617A, the sector audio data 627A, or both, to an audio enhancer 134A associated with the sector 654A. The audio enhancer 134A processes the sector audio data 617A, the sector audio data 627A, or both, to generate enhanced audio data 135A. To illustrate, the audio enhancer 134A performs one or more similar operations as described with reference to the audio enhancer 134 to generate the enhanced audio data 135. In a particular aspect, the sector audio data 617A corresponds to audio captured by the microphone 110 that appears to be from the sector 654A and the sector audio data 627A corresponds to audio captured by the microphone 120 that appears to be from the sector 654A. In a particular embodiment, generating the enhanced audio data 135 based on the sector audio data 617A and the sector audio data 627A corresponds to using audio captured by different microphones that appears to be from the same sector 654A to generate the enhanced audio data 135 of the sector 654A.

In another example, the audio processor 138 provides the sector audio data 617B, the sector audio data 627B, or both, to an audio enhancer 134B associated with the sector 654B. The audio enhancer 134B processes the sector audio data 617B, the sector audio data 627B, or both, to generate enhanced audio data 135B. In yet another example, the audio enhancer 134C processes the sector audio data 617C, the sector audio data 627C, or both, to generate enhanced audio data 135C. Similarly, the audio enhancer 134D processes the sector audio data 617D, the sector audio data 627D, or both, to generate enhanced audio data 135D.

The spatial output selector 634 determines selected spatial audio data 646 as one or more of the enhanced audio data 135A, the enhanced audio data 135B, the enhanced audio data 135C, the enhanced audio data 135D, one or more additional sets of enhanced audio data, or a combination thereof. In a particular aspect, the spatial output selector 634 selects the spatial audio data 646 based on sound metrics, sensor input 312, or a combination thereof.

In a particular optional embodiment, the spatial output selector 634 generates a first sound metric of the enhanced audio data 135A, a second sound metric of the enhanced audio data 135B, a third sound metric of the enhanced audio data 135C, a fourth sound metric of the enhanced audio data 135D, one or more additional sound metrics of one or more additional sets of enhanced audio data, or a combination thereof. In some examples, a sound metric includes a speech quality metric, a speech intelligibility metric, or both. In some examples, a sound metric includes an SNR.

In a particular aspect, the spatial output selector 634 determines the selected spatial audio data 646 based at least in part on a comparison of the sound metrics. For example, the spatial output selector 634, based at least in part on determining that the first sound metric is highest among the sound metrics, selects the enhanced audio data 135A to be included in the selected spatial audio data 646. In another example, the spatial output selector 634, in response to determining that the third sound metric is less than a threshold, refrains from including the enhanced audio data 135C in the selected spatial audio data 646.

In a particular aspect, the spatial output selector 634 determines the selected spatial audio data 646 based at least in part on the sensor input 312. For example, the spatial output selector 634, in response to determining that the sensor input 312 indicates that a particular sound source is detected in the sector 654A, selects the enhanced audio data 135A to be included in the selected spatial audio data 646. As another example, the spatial output selector 634, in response to determining that the sensor input 312 indicates that an occlusion is detected in the sector 654D, refrains from including the enhanced audio data 135D in the selected spatial audio data 646. In a particular aspect, the spatial output selector 634, in response to determining that the sensor input 312 indicates a device orientation 526 (e.g., a particular phone orientation), selects the enhanced audio data 135A corresponding to a target sector (e.g., the sector 654A) associated with the device orientation 526 to be included in the selected spatial audio data 646.

The audio processor 138 generates the enhanced audio data 135 based on the selected spatial audio data 646. In a particular aspect, the selected spatial audio data 646 includes audio data of a single sector and the audio processor 138 outputs the selected spatial audio data 646 as the enhanced audio data 135. In another aspect, the selected spatial audio data 646 includes audio data of multiple sectors and the audio processor 138 generates the enhanced audio data 135 based on a combination of the sets of audio data included in the selected spatial audio data 646. In an example, the selected spatial audio data 646 includes the enhanced audio data 135A and the enhanced audio data 135B, and the audio processor 138 generates the enhanced audio data 135 based on a combination of the enhanced audio data 135A and the enhanced audio data 135B.

In some optional embodiments, the spatial sector audio extractor 640 selects spatial sectors and generates sector audio data of the selected sectors. For example, the spatial sector audio extractor 640 selects the sector 654A and the sector 654B based on the sensor input 312, a user input, a configuration setting, default data, or a combination thereof. In a particular aspect, the spatial sector audio extractor 640 selects the sector 654A based at least in part on determining that a particular sound source (e.g., a particular person) is detected in the sector 654A, that a particular sound type (e.g., speech) is detected in the sector 654A, that an occlusion is not detected in the sector 654A, that a user selection indicates the sector 654A, or a combination thereof.

The spatial sector audio extractor 640, in response to determining that the sector 654A and the sector 654B are selected, processes the audio data 117 to generate the sector audio data 617A and the sector audio data 617B, and refrains from generating (or discards) audio data associated with the sector 654C and the sector 654D. Similarly, the spatial sector audio extractor 640, in response to determining that the sector 654A and the sector 654B are selected, processes the audio data 127 to generate the sector audio data 627A and the sector audio data 627B, and refrains from generating (or discards) audio data associated with the sector 654C and the sector 654D.

In these embodiments, the audio enhancer 134A processes the sector audio data 617A and the sector audio data 627A to generate the enhanced audio data 135A associated with the sector 654A and the audio enhancer 134B processes the sector audio data 617B and the sector audio data 627B to generate the enhanced audio data 135B associated with the sector 654B. The audio processor 138 refrains from generating the enhanced audio data 135C and the enhanced audio data 135D corresponding to the sector 654C and the sector 654D that are not selected. The spatial output selector 634 determines the selected spatial audio data 646 based on the enhanced audio data 135A and the enhanced audio data 135B.

In some optional embodiments, the audio enhancer 134 can bypass the subband audio enhancement (e.g., the audio enhancer 134A-D) for one or more spatial sectors. For example, the audio enhancer 134 generates enhanced audio data 135A based on the sector audio data 617A, the sector audio data 627A, or both. To illustrate, the enhanced audio data 135A can correspond to a weighted combination of the sector audio data 617A and the sector audio data 627A. In another aspect, the audio enhancer 134 can perform other types of audio enhancement (e.g., across the frequency band enhancement) based on the sector audio data 617A, the sector audio data 627A, or both, to generate the enhanced audio data 135A.

In yet another example, the audio enhancer 134 uses subband audio enhancement to generate enhanced audio data of at least one sector and bypasses subband audio enhancement to generate enhanced audio data of at least one other sector. For example, the audio enhancer 134 uses the audio enhancer 134A to process the sector audio data 617A, the sector audio data 627A, or both, to generate the enhanced audio data 135A, and bypasses the audio enhancer 134B to generate the enhanced audio data 135B based on the sector audio data 617B, the sector audio data 627B, or both.

In a particular aspect, the audio enhancer 134 determines whether to bypass subband audio enhancement for a particular sector based on the sensor input 312, a user input, a configuration setting, default data, or a combination thereof. For example, the audio enhancer 134 selects to perform subband audio enhancement for the sector 654A based on determining that a particular sound source is detected in the sector 654A, and bypasses subband audio enhancement for the sector 654B based on determining that another sound source is detected in the sector 654B.

A technical advantage of performing subband audio enhancement based on spatial sectors includes using audio captured by different microphones from the same sector to enhance audio for the sector. Each of the audio enhancers 134A-D can include machine-learning models (e.g., the audio subband enhancers 144 of FIG. 1) that are trained for a particular subband and a particular sector. A machine-learning model that is targeted for a particular sector can be less complex and more efficient than a machine-learning model for the entire three-dimensional audio scene.

Referring to FIG. 6B, a diagram is shown of an illustrative aspect of a system 660 operable to perform machine-learning based audio subband processing. In a particular aspect, the system 100 of FIG. 1 can include one or more components of the system 660.

The spatial sector audio extractor 640 generates sector audio data associated with spatial sectors of an audio scene, as described with reference to FIG. 6A. For example, the spatial sector audio extractor 640 generates the sector audio data 617A, the sector audio data 627A, or both, of the sector 654A. As another example, the spatial sector audio extractor 640 generates the sector audio data 617B, the sector audio data 627B, or both, of the sector 654B.

The audio frequency splitter 142 generates subband audio data for audio data of each sector. For example, the audio frequency splitter 142 processes sector audio data 617A to generate sector subband audio data 618AA associated with a first frequency subband and sector subband audio data 618AB associated with a second frequency subband. The sector subband audio data 618AA represents the first frequency subband of audio from the sector 654A captured by the microphone 110. The sector subband audio data 618AB represents the second frequency subband of audio from the sector 654A captured by the microphone 110.

As another example, the audio frequency splitter 142 processes sector audio data 617B to generate sector subband audio data 618BA associated with the first frequency subband and sector subband audio data 618BB associated with the second frequency subband. The sector subband audio data 618BA represents the first frequency subband of audio from the sector 654B captured by the microphone 110. The sector subband audio data 618AB represents the second frequency subband of audio from the sector 654B captured by the microphone 110.

In an example, the audio frequency splitter 142 processes sector audio data 627A to generate sector subband audio data 628AA associated with the first frequency subband and sector subband audio data 628AB associated with the second frequency subband. The sector subband audio data 628AA represents the first frequency subband of audio from the sector 654A captured by the microphone 120. The sector subband audio data 628AB represents the second frequency subband of audio from the sector 654A captured by the microphone 120.

As another example, the audio frequency splitter 142 processes sector audio data 627B to generate sector subband audio data 628BA associated with the first frequency subband and sector subband audio data 628BB associated with the second frequency subband. The sector subband audio data 628BA represents the first frequency subband of audio from the sector 654B captured by the microphone 120. The sector subband audio data 628BB represents the second frequency subband of audio from the sector 654B captured by the microphone 120.

It should be understood that the spatial sector audio extractor 640 generating sector audio data for two sectors and the audio frequency splitter 142 generating subband audio data for two frequency subbands is provided for ease of illustration, in other examples the spatial sector audio extractor 640 can generate sector audio data for more than two sectors and the audio frequency splitter 142 can generate subband audio data for more than two frequency subbands.

One or more audio subband enhancers 144 process sets of sector subband audio data associated with a corresponding frequency subband to generate enhanced audio data of the frequency subband. For example, the audio subband enhancer 144A processes subband audio data of the first frequency subband to generate enhanced audio data 135A. To illustrate, the audio subband enhancer 144A processes the sector subband audio data 618AA, the sector subband audio data 628AA, the sector subband audio data 618BA, the sector subband audio data 628BA, or a combination thereof, to generate the enhanced audio data 135A. As another example, the audio subband enhancer 144B processes the sector subband audio data 618AB, the sector subband audio data 628AB, the sector subband audio data 618BB, the sector subband audio data 628BB, or a combination thereof, to generate enhanced audio data 135B.

In a particular optional embodiment, the spatial sector audio extractor 640 determines that a target sound source (e.g., such as a person, a musical instrument, a user selected sound source, etc.) is detected in the sector 654A and that a second sound source (e.g., a sound source to be removed) is detected in the sector 654B. For example, the spatial sector audio extractor 640 detects a particular sound source in a particular sector based on the sensor input 312, a user input, or both.

The spatial sector audio extractor 640 provides an indication to the audio subband enhancer 144A that subband audio data (e.g., the sector subband audio data 618AA, the sector subband audio data 628AA, or both) of the sector 654A correspond to a target sound source to be retained. In a particular aspect, the spatial sector audio extractor 640 provides an indication to the audio subband enhancer 144A that subband audio data (e.g., the sector subband audio data 618BA, the sector subband audio data 628BA, or both) of the sector 654B is to be removed. The audio subband enhancer 144A performs audio enhancement (e.g., noise suppression, echo cancellation, or both) of the subband audio of the sector 654A based on (e.g., to remove audio corresponding to) the subband audio data of the sector 654B to generate the enhanced audio data 135A. The combiner 148 generates the enhanced audio data 135 based on the enhanced audio data 135A, the enhanced audio data 135B, one or more additional sets of enhanced audio data, or a combination thereof, as described with reference to FIG. 1.

A technical advantage of subband processing of sector audio data can include using audio data from different sectors to generate enhanced subband audio data. For example, subband audio data from one sector can be used for noise cancellation of subband audio data from another sector.

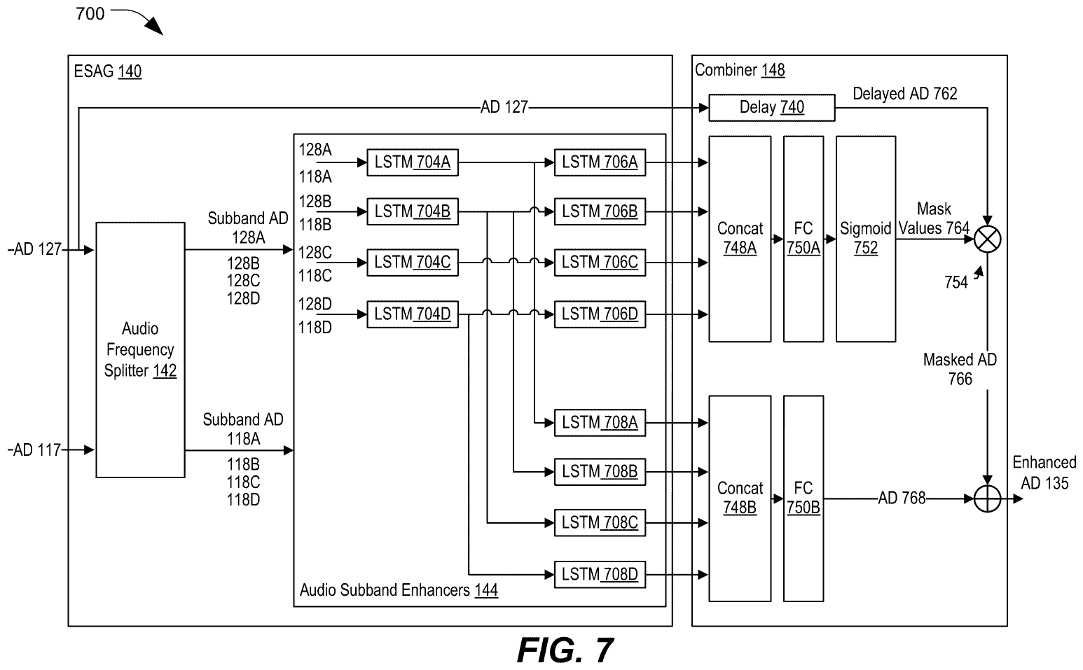

Referring to FIG. 7, a diagram 700 is shown of an illustrative aspect of components of a system of any of FIGS. 1-6B. In a particular aspect, the diagram 700 includes an example of an illustrative optional embodiment of the enhanced subband audio generator 140 and an example of an illustrative optional embodiment of the combiner 148.

The audio subband enhancers 144 include a plurality of machine-learning models (e.g., LSTMs) associated with respective subbands. For example, an LSTM 704A coupled to an LSTM 706A and an LSTM 708A corresponds to an audio subband enhancer 144A associated with a first frequency subband. As another example, an LSTM 704B coupled to an LSTM 706B and an LSTM 708B corresponds to an audio subband enhancer 144B associated with a second frequency subband. As yet another example, an LSTM 704C coupled to an LSTM 706C and an LSTM 708C corresponds to an audio subband enhancer 144C associated with a third frequency subband. In an additional example, an LSTM 704D coupled to an LSTM 706D and an LSTM 708D corresponds to an audio subband enhancer 144D associated with a fourth frequency subband. It should be understood that the enhanced subband audio generator 140 including audio subband enhancers 144 corresponding to four frequency subbands is provided as an illustrative example, in other examples the enhanced subband audio generator 140 can include audio subband enhancers 144 associated with fewer than four frequency subbands or more than four frequency subbands.

The combiner 148 includes a concatenation layer 748A coupled to a fully connected layer 750A. The combiner 148 also includes a concatenation layer 748B coupled to a fully connected layer 750B. The audio subband enhancer 144A processes audio data (e.g., the subband audio data 118A, the subband audio data 128A, one or more additional sets of subband audio data, or a combination thereof) representing the first frequency subband to generate an output that is provided to each of the LSTM 706A and the LSTM 708A of the audio subband enhancer 144A.

The audio frequency splitter 142 processes the audio data 117 to generate subband audio data 118A, subband audio data 118B, subband audio data 118C, and subband audio data 118D corresponding to the first frequency subband, the second frequency subband, the third frequency subband, and the fourth frequency subband, respectively. The audio frequency splitter 142 processes the audio data 127 to generate subband audio data 128A, subband audio data 128B, subband audio data 128C, and subband audio data 128D corresponding to the first frequency subband, the second frequency subband, the third frequency subband, and the fourth frequency subband, respectively.

The audio frequency splitter 142 provides subband audio data of a frequency subband to a corresponding LSTM 704. For example, the audio frequency splitter 142 provides the subband audio data 118A, the subband audio data 128A, or both, to the LSTM 704A. As another example, the audio frequency splitter 142 provides the subband audio data 118B, the subband audio data 128B, or both, to the LSTM 704B. An output of a LSTM 704 is provided to the corresponding LSTM 706, the corresponding LSTM 708, or both. For example, an output of the LSTM 704A is provided to the LSTM 706A, the LSTM 708A, or both.

Outputs of the LSTMs 706 are provided to the concatenation layer 748A and outputs of the LSTMs 708 are provided to the concatenation layer 748B. For example, an output of the LSTM 706A is provided to the concatenation layer 748A and an output of the LSTM 708A is provided to the concatenation layer 748B. In a particular aspect, the output of the LSTM 706A, the output of the LSTM 708A, or both, correspond to the enhanced subband audio data 136A of FIG. 1.

The concatenation layer 748A concatenates outputs of the LSTM 706A, the LSTM 706B, the LSTM 706C, the LSTM 706D, one or more additional LSTMs, or a combination thereof, to generate first concatenated audio data representing a frequency band. In an example, the frequency band includes the first frequency subband, the second frequency subband, the third frequency subband, the fourth frequency subband, one or more additional frequency subbands, or a combination thereof. The first concatenated audio data is processed by the fully connected layer 750A. The combiner 148 applies a sigmoid function 752 to an output of the fully connected layer 750A to generate mask values 764. For example, an output of the fully connected layer 750A includes a first count of values (e.g., 257 integer values). Applying the sigmoid function 752 to the output of the fully connected layer 750A generates the first count of mask values 764 (e.g., 257 mask values). In a particular optional embodiment, a mask value is either a 0 or a 1.

The combiner 148 applies a delay 740 to the audio data 127 to generate delayed audio data 762. The combiner 148 includes a multiplier 754 that applies the mask values 764 to the delayed audio data 762 to generate masked audio data 766. For example, the delayed audio data 762 includes the first count of values (e.g., 257 values) and applying the mask values 764 to the delayed audio data 762 includes applying a first mask value to a first value of the delayed audio data 762 to generate a first value of the masked audio data 766. In a particular optional embodiment, if the first mask value is 0, the first value of the masked audio data 766 is 0. Alternatively, if the first mask value is 1, the first value of the masked audio data 766 is the same as the first value of the delayed audio data 762. The mask values 764 thus enable selected values of the delayed audio data 762 to be included in the masked audio data 766.

The concatenation layer 748B concatenates outputs of the LSTM 708A, the LSTM 708B, the LSTM 708C, the LSTM 708D, one or more additional LSTMs, or a combination thereof, to generate second concatenated audio data representing the frequency band. The second concatenated audio data is processed by the fully connected layer 750B to generate audio data 768. The combiner 148 generates the enhanced audio data 135 based on a combination of the masked audio data 766 and the audio data 768.

In a particular optional embodiment, model architectures of the audio subband enhancers 144 are based on the subband enhancer data 346, as described with reference to FIG. 3. In an example, each of the LSTMs of the audio subband enhancer 144A includes two hidden layers, each of the LSTMs of the audio subband enhancer 144B includes two hidden layers, each of the LSTMs of the audio subband enhancer 144C includes four hidden layers, and each of the LSTMs of the audio subband enhancer 144D includes four hidden layers. In a particular aspect, the audio subband enhancers 144 and the combiner 148 correspond to a SGN. In a particular aspect, the audio subband enhancers 144 include multiple LSTMs for generating enhanced audio data of respective subbands that are smaller as a group than a single LSTM that is configured to generate enhanced audio data for all of the frequency band.

It should be understood that applying the delay 740 to the audio data 127 to generate the delayed audio data 762 is provided as an illustrative example. In another example, the delay 740 can be applied to the audio data 117, the audio data 127, or a combination thereof, to generate the delayed audio data 762.

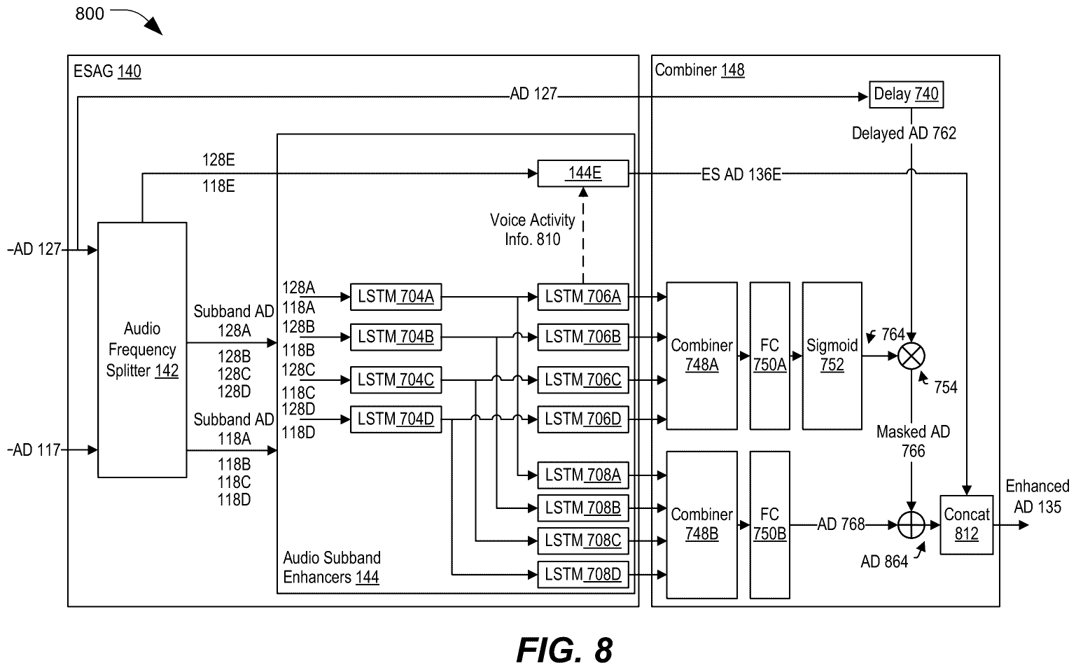

Referring to FIG. 8, a diagram 800 is shown of an illustrative aspect of operation of components of a system of any of FIGS. 1-6B. In a particular aspect, the diagram 800 includes an example of an illustrative optional implementation of the enhanced subband audio generator 140 and an example of an illustrative optional implementation of the combiner 148.

In a particular optional embodiment, one or more of the audio subband enhancers 144 are configured to perform procedural signal processing. For example, the audio subband enhancers 144 include an audio subband enhancer 144E configured to use procedural signal processing to process audio data of a fifth frequency subband to generate enhanced subband audio data 136E of the fifth frequency subband.

In an illustrative example, the audio frequency splitter 142 processes the audio data 117 to generate subband audio data 118E of a fifth frequency subband in addition to generating the subband audio data 118A, the subband audio data 118B, the subband audio data 118C, and the subband audio data 118D. The audio frequency splitter 142 processes the audio data 127 to generate subband audio data 128E of the fifth frequency subband in addition to generating the subband audio data 118A, the subband audio data 118B, the subband audio data 118C, and the subband audio data 118D. The audio frequency splitter 142 generating audio data associated with five frequency subbands is provided as an illustrative example, in other examples the audio frequency splitter 142 can generate audio data associated with fewer than five or more than five frequency subbands.

The audio subband enhancer 144E applies procedural signal processing to the subband audio data 118E, the subband audio data 128E, or a combination thereof, to generate the enhanced subband audio data 136E. In an optional embodiment, the audio subband enhancer 144E applies the procedural signal processing based on voice activity information 810 from one or more of the audio subband enhancers 144A-D. In a particular aspect, the fifth frequency subband (e.g., 8-16 kHz) corresponds to a higher frequency range and subband SGN processing (e.g., using generative networks, such as LSTMs) is bypassed for the higher frequency range because speech in the higher frequency range appears similar to noise to generative networks. In some optional embodiments, the audio subband enhancer 144E includes a machine-learning model other than a generative network.

The combiner 148 generates audio data 864 based on a combination of the masked audio data 766 and the audio data 768. The audio data 864 is of a particular frequency subband (e.g., the first frequency subband, the second frequency subband, the third frequency subband, and the fourth frequency subband). The combiner 148 includes a concatenation layer 812 that concatenates the audio data 864 and the enhanced subband audio data 136E to generate the enhanced audio data 135. The enhanced audio data 135 is of a frequency band (e.g., the particular frequency subband and the fifth frequency subband).

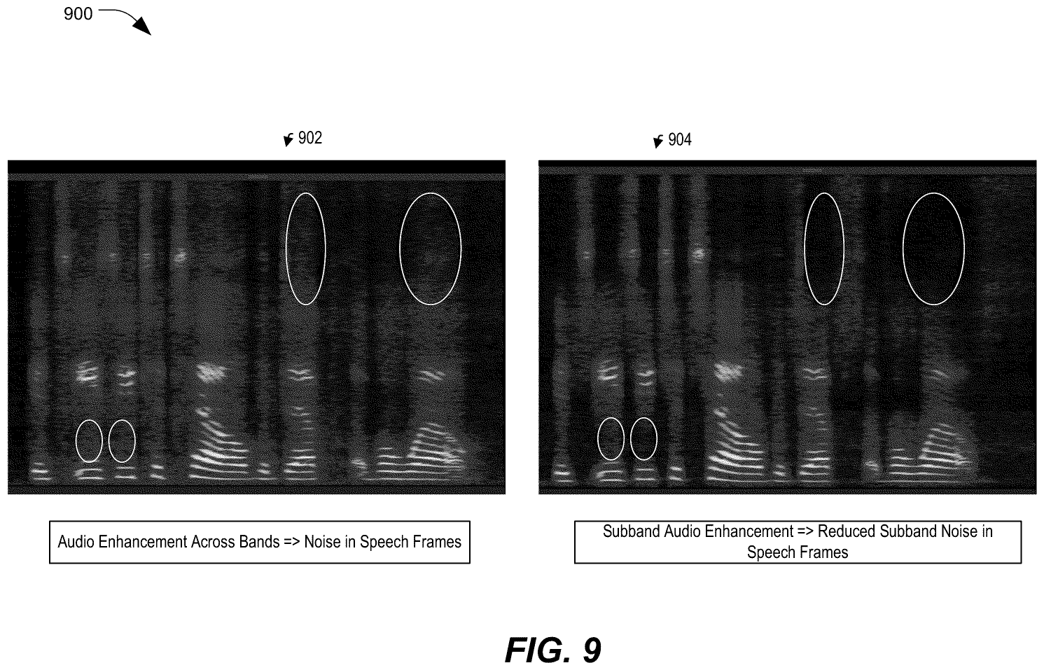

Referring to FIG. 9, a diagram 900 of an illustrative example of output of machine-learning based audio subband processing is shown. In an example 902, across-frequency-band processing is performed to generate enhanced audio data. In an example 904, subband processing is performed to generate the enhanced audio data 135, as described with reference to FIGS. 1-8.

Noise suppression in subband portions of the enhanced audio data in the example 902 is not as effective because other subband portions of the enhanced audio data include speech that is to be retained and processing is performed across the frequency band. In the example 904, noise suppression in one subband can be independent of speech retention in another subband. Noise can thus be more effectively suppressed (e.g., removed) in one frequency subband (e.g., a higher frequency subband) while retaining speech audio data in another frequency sub-band (e.g., a lower frequency subband).

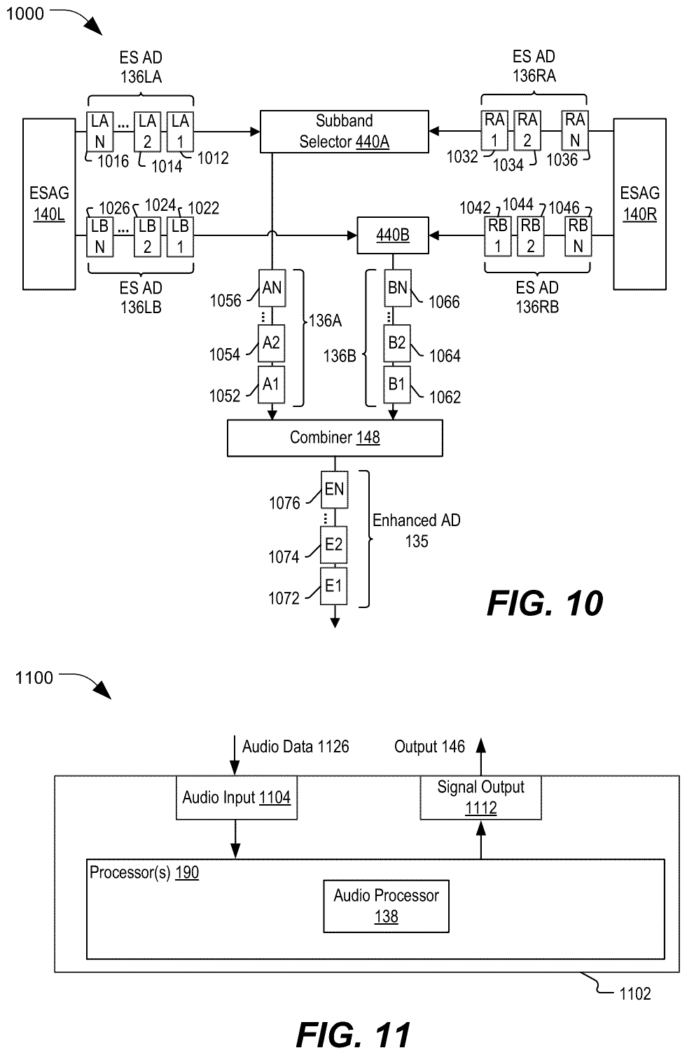

FIG. 10 is a diagram of an illustrative aspect of operation of components of the system 400 of FIG. 4A, in accordance with some examples of the present disclosure.

The enhanced subband audio generator 140L is configured to generate a sequence of enhanced subband audio data samples, such as a sequence of frames of the enhanced subband audio data 136LA of a first frequency subband, illustrated as a first frame (LA1) 1012, a second frame (LA2) 1014, and one or more additional frames including an Nth frame (LAN) 1016 (where N is an integer greater than two).

The enhanced subband audio generator 140L is configured to generate one or more additional sequences of enhanced subband audio data samples, such as a sequence of frames of the enhanced subband audio data 136LB of a second frequency subband, illustrated as a first frame (LB1) 1022, a second frame (LB2) 1024, and one or more additional frames including an Nth frame (LBN) 1026.

The enhanced subband audio generator 140R is configured to generate a sequence of enhanced subband audio data samples, such as a sequence of frames of the enhanced subband audio data 136RA of the first frequency subband, illustrated as a first frame (RA1) 1032, a second frame (RA2) 1034, and one or more additional frames including an Nth frame (RAN) 1036.

The enhanced subband audio generator 140R is configured to generate one or more additional sequences of enhanced subband audio data samples, such as a sequence of frames of the enhanced subband audio data 136RB of the second frequency subband, illustrated as a first frame (RB1) 1042, a second frame (RB2) 1044, and one or more additional frames including an Nth frame (RBN) 1046.

The subband selector 440A is configured to receive a sequence of enhanced subband audio data samples of the first frequency subband, such as a sequence of frames of the enhanced subband audio data 136LA, from the enhanced subband audio generator 140L. The subband selector 440A is also configured to receive a sequence of enhanced audio data samples of the first frequency subband, such as a sequence of frames of the enhanced subband audio data 136RA, from the enhanced subband audio generator 140R. The subbands selector 440A is configured to output a sequence of enhanced subband audio data samples of the first frequency subband, such as a sequence of frames of the enhanced subband audio data 136A.

The subband selector 440B is configured to receive a sequence of enhanced subband audio data samples of the second frequency subband, such as a sequence of frames of the enhanced subband audio data 136LB, from the enhanced subband audio generator 140L. The subband selector 440B is also configured to receive a sequence of enhanced audio data samples of the second frequency subband, such as a sequence of frames of the enhanced subband audio data 136RB, from the enhanced subband audio generator 140R. The subbands selector 440B is configured to output a sequence of enhanced subband audio data samples of the second frequency subband, such as a sequence of frames of the enhanced subband audio data 136B.

The combiner 148 is configured to receive a sequence of enhanced subband audio data samples of the first frequency subband, such as a sequence of frames of the enhanced subband audio data 136A, from the subband selector 440A. The combiner 148 is also configured to receive a sequence of enhanced subband audio data samples of the second frequency subband, such as a sequence of frames of the enhanced subband audio data 136B, from the subband selector 440B. The combiner 148 is configured to generate a sequence of enhanced audio data samples of a frequency band, such as a sequence of frames of the enhanced audio data 135.

During operation, the subband selector 440A processes the first frame (LA1) 1012 and the first frame (RA1) 1032 to generate a first frame (A1) 1052 of the enhanced subband audio data 136A. For example, the subband selector 440A selects one of the first frame (LA1) 1012 or the first frame (RA1) 1032 to output as the first frame (A1) 1052. In another example, the subband selector 440A generates the first frame (A1) 1052 based on a combination of the first frame (LA1) 1012 and the first frame (RA1) 1032. Similarly, the subband selector 440B processes the first frame (LB1) 1022 and the first frame (RB1) 1042 to generate a first frame (B1) 1062 of the enhanced subband audio data 136B. The combiner 148 generates a first frame (E1) 1072 of the enhanced audio data 135 based on a combination of the first frame (A1) 1052 and the first frame (B1) 1062.

The subband selector 440A processes the second frame (LA2) 1014 and the second frame (RA2) 1034 to generate a second frame (A2) 1054 of the enhanced subband audio data 136A. Similarly, the subband selector 440B processes the second frame (LB2) 1024 and the second frame (RB2) 1044 to generate a second frame (B2) 1064 of the enhanced subband audio data 136B. The combiner 148 generates a second frame (E2) 1074 of the enhanced audio data 135 based on a combination of the second frame (A2) 1054 and the second frame (B2) 1064.

Such processing continues, including the subband selector 440A processing the Nth frame (LAN) 1016 and the Nth frame (RAN) 1036 to generate an Nth frame (AN) 1056 of the enhanced subband audio data 136A. Similarly, the subband selector 440B processes the Nth frame (LBN) 1026 and the Nth frame (RBN) 1046 to generate an Nth frame (BN) 1066 of the enhanced subband audio data 136B. The combiner 148 generates a Nth frame (EN) 1076 of the enhanced audio data 135 based on a combination of the Nth frame (AN) 1056 and the Nth frame (BN) 1066.

By dynamically selecting a frame from either the enhanced subband audio generator 140L or the enhanced subband audio generator 140R to output as an enhanced subband audio frame, audio data from different microphones can be selected as audio quality of sound captured by the microphones changes, e.g., due a change in position of the sound sources, changes in positions of occlusions, noise conditions, etc.

FIG. 11 depicts an implementation 1100 of the device 102 as an integrated circuit 1102 that includes the one or more processors 190. The integrated circuit 1102 also includes an audio input 1104, such as one or more bus interfaces, to enable the audio data 1126 to be received for processing. In a particular aspect, the audio data 1126 includes the audio data 116, the audio data 126, the audio data 117, the audio data 127 of FIG. 1, or a combination thereof.

The integrated circuit 1102 also includes a signal output 1112, such as a bus interface, to enable sending of an output signal, such as the output 146. The integrated circuit 1102 includes one or more components of the audio processor 138. The integrated circuit 1102 enables implementation of machine-learning based audio subband processing as a component in a system that includes microphones, such as a mobile phone or tablet as depicted in FIG. 12, a headset as depicted in FIG. 13, a wearable electronic device as depicted in FIG. 14, glasses as depicted in FIG. 15, earbuds as depicted in FIG. 16, a voice-controlled speaker system as depicted in FIG. 17, a camera as depicted in FIG. 18, a virtual reality, mixed reality, or augmented reality headset as depicted in FIG. 19, or a vehicle as depicted in FIG. 20 or FIG. 21.

FIG. 12 depicts an implementation 1200 in which the device 102 includes a mobile device 1202, such as a phone or tablet, as illustrative, non-limiting examples. The mobile device 1202 includes the microphone 110, the microphone 120, and a display screen 1204. Components of the one or more processors 190, including the audio processor 138, are integrated in the mobile device 1202 and are illustrated using dashed lines to indicate internal components that are not generally visible to a user of the mobile device 1202. In a particular example, the audio processor 138 operates to generate the enhanced audio data 135 and to detect user voice activity in the enhanced audio data 135, which is then processed to perform one or more operations at the mobile device 1202, such as to launch a graphical user interface or otherwise display other information associated with the user's speech at the display screen 1204 (e.g., via an integrated “smart assistant” application).

FIG. 13 depicts an implementation 1300 in which the device 102 includes a headset device 1302. The headset device 1302 includes the microphone 110 and the microphone 120. Components of the one or more processors 190, including one or more components of the audio processor 138, are integrated in the headset device 1302. In a particular example, the audio processor 138 generates the enhanced audio data 135 and operates to detect user voice activity in the enhanced audio data 135, which may cause the headset device 1302 to perform one or more operations at the headset device 1302, to transmit audio data corresponding to the user voice activity to a second device (not shown) for further processing, or a combination thereof.

FIG. 14 depicts an implementation 1400 in which the device 102 includes a wearable electronic device 1402, illustrated as a “smart watch.” The audio processor 138, the microphone 110, and the microphone 120 are integrated into the wearable electronic device 1402. In a particular example, the audio processor 138 generates the enhanced audio data 135 and operates to detect user voice activity in the enhanced audio data 135, which is then processed to perform one or more operations at the wearable electronic device 1402, such as to launch a graphical user interface or otherwise display other information associated with the user's speech at a display screen 1404 of the wearable electronic device 1402. To illustrate, the wearable electronic device 1402 may include a display screen that is configured to display a notification based on user speech detected by the wearable electronic device 1402. In a particular example, the wearable electronic device 1402 includes a haptic device that provides a haptic notification (e.g., vibrates) in response to detection of user voice activity. For example, the haptic notification can cause a user to look at the wearable electronic device 1402 to see a displayed notification indicating detection of a keyword spoken by the user. The wearable electronic device 1402 can thus alert a user with a hearing impairment or a user wearing a headset that the user's voice activity is detected.

FIG. 15 depicts an implementation 1500 in which the device 102 includes a portable electronic device that corresponds to augmented reality or mixed reality glasses 1502. The glasses 1502 include a holographic projection unit 1504 configured to project visual data onto a surface of a lens 1506 or to reflect the visual data off of a surface of the lens 1506 and onto the wearer's retina. One or more components of the audio processor 138, the microphone 110R, the microphone 120R, the microphone 110L, the microphone 120L, or a combination thereof, are integrated into the glasses 1502. The audio processor 138 may function to generate the enhanced audio data 135 based on audio signals received from the microphone 110L, the microphone 120L, the microphone 110R, the microphone 120R, or a combination thereof. In a particular example, the holographic projection unit 1504 is configured to display a notification indicating user speech detected in the enhanced audio data 135. In a particular example, the holographic projection unit 1504 is configured to display a notification indicating a detected audio event. For example, the notification can be superimposed on the user's field of view at a particular position that coincides with the location of the source of the sound associated with the audio event. To illustrate, the sound may be perceived by the user as emanating from the direction of the notification. In an illustrative implementation, the holographic projection unit 1504 is configured to display a notification of a detected audio event or environment, such as based on the sensor input 312, the context indicator 328, or both.

FIG. 16 depicts an implementation 1600 in which the device 102 includes a portable electronic device that corresponds to a pair of earbuds 1606 that includes a first earbud 1602 and a second earbud 1604. Although earbuds are described, it should be understood that the present technology can be applied to other in-ear or over-ear playback devices.

The first earbud 1602 includes a first microphone 1620, such as a high signal-to-noise microphone positioned to capture the voice of a wearer of the first earbud 1602, an array of one or more other microphones configured to detect ambient sounds and spatially distributed to support beamforming, illustrated as microphones 1622A, 1622B, and 1622C, an “inner” microphone 1624 proximate to the wearer's ear canal (e.g., to assist with active noise cancelling), and a self-speech microphone 1626, such as a bone conduction microphone configured to convert sound vibrations of the wearer's ear bone or skull into an audio signal.

In a particular implementation, the first microphone 1620 corresponds to the microphone 110 and the microphones 1622A, 1622B, and 1622C correspond to multiple instances of the microphone 120, and audio signals generated by the microphones 1620 and 1622A, 1622B, and 1622C are provided to the audio processor 138. The audio processor 138 may function to generate the enhanced audio data 135 based on the audio signals. In some implementations, the audio processor 138 may further be configured to process audio signals from one or more other microphones of the first earbud 1602, such as the inner microphone 1624, the self-speech microphone 1626, or both.

The second earbud 1604 can be configured in a substantially similar manner as the first earbud 1602. In some implementations, the audio processor 138 of the first earbud 1602 is also configured to receive one or more audio signals generated by one or more microphones of the second earbud 1604, such as via wireless transmission between the earbuds 1602, 1604, or via wired transmission in implementations in which the earbuds 1602, 1604 are coupled via a transmission line. In other implementations, the second earbud 1604 also includes an audio processor 138, enabling techniques described herein to be performed by a user wearing a single one of either of the earbuds 1602, 1604.

In some implementations, the earbuds 1602, 1604 are configured to automatically switch between various operating modes, such as a passthrough mode in which ambient sound is played via a speaker 1630, a playback mode in which non-ambient sound (e.g., streaming audio corresponding to a phone conversation, media playback, video game, etc.) is played back through the speaker 1630, and an audio zoom mode or beamforming mode in which one or more ambient sounds are emphasized and/or other ambient sounds are suppressed for playback at the speaker 1630. In other implementations, the earbuds 1602, 1604 may support fewer modes or may support one or more other modes in place of, or in addition to, the described modes.

In an illustrative example, the earbuds 1602, 1604 can automatically transition from the playback mode to the passthrough mode in response to detecting the wearer's voice, and may automatically transition back to the playback mode after the wearer has ceased speaking. In some examples, the earbuds 1602, 1604 can operate in two or more of the modes concurrently, such as by performing audio zoom on a particular ambient sound (e.g., a dog barking) and playing out the audio zoomed sound superimposed on the sound being played out while the wearer is listening to music (which can be reduced in volume while the audio zoomed sound is being played). In this example, the wearer can be alerted to the ambient sound associated with the audio event without halting playback of the music.

FIG. 17 is an implementation 1700 in which the device 102 includes a wireless speaker and voice activated device 1702. The wireless speaker and voice activated device 1702 can have wireless network connectivity and is configured to execute an assistant operation. The one or more processors 190 including one or more components of the audio processor 138, the microphone 110, the microphone 120, or a combination thereof, are included in the wireless speaker and voice activated device 1702. The wireless speaker and voice activated device 1702 also includes a speaker 1704. During operation, in response to receiving a verbal command identified as user speech in the enhanced audio data 135 generated via operation of the audio processor 138, the wireless speaker and voice activated device 1702 can execute assistant operations, such as via execution of a voice activation system (e.g., an integrated assistant application). The assistant operations can include adjusting a temperature, playing music, turning on lights, etc. For example, the assistant operations are performed responsive to receiving a command after a keyword or key phrase (e.g., “hello assistant”).

FIG. 18 depicts an implementation 1800 in which the device 102 includes a portable electronic device that corresponds to a camera device 1802. The audio processor 138, the microphone 110, the microphone 120, or a combination thereof, are included in the camera device 1802. During operation, in response to receiving a verbal command identified as user speech in the enhanced audio data 135 generated via operation of the audio processor 138, the camera device 1802 can execute operations responsive to spoken user commands, such as to adjust image or video capture settings, image or video playback settings, or image or video capture instructions, as illustrative examples.

FIG. 19 depicts an implementation 1900 in which the device 102 includes a portable electronic device that corresponds to a virtual reality, mixed reality, or augmented reality headset 1902. The audio processor 138, the microphone 110, the microphone 120, or a combination thereof, are integrated into the headset 1902. In a particular aspect, the headset 1902 includes the microphone 110 positioned to primarily capture speech of a user and the microphone 120 positioned to primarily capture environmental sounds. User voice activity detection can be performed on the enhanced audio data 135 based on audio signals received from the microphone 110 and the microphone 120 of the headset 1902. A visual interface device is positioned in front of the user's eyes to enable display of augmented reality, mixed reality, or virtual reality images or scenes to the user while the headset 1902 is worn. In a particular example, the visual interface device is configured to display a notification indicating user speech detected in the enhanced audio data 135.

FIG. 20 depicts an implementation 2000 in which the device 102 corresponds to, or is integrated within, a vehicle 2002, illustrated as a manned or unmanned aerial device (e.g., a package delivery drone). The audio processor 138, the microphone 110, the microphone 120, or a combination thereof, are integrated into the vehicle 2002. User voice activity detection can be performed on the enhanced audio data 135 that is based on audio signals received from the microphone 110 and the microphone 120 of the vehicle 2002, such as for delivery instructions from an authorized user of the vehicle 2002.

FIG. 21 depicts another implementation 2100 in which the device 102 corresponds to, or is integrated within, a vehicle 2102, illustrated as a car. The vehicle 2102 includes the one or more processors 190 including the audio processor 138. The vehicle 2102 also includes the microphone 110 and the microphone 120. The microphone 110 is positioned to capture utterances of an operator of the vehicle 2102. User voice activity detection can be performed on the enhanced audio data 135 that is based on audio signals received from the microphone 110 and the microphone 120 of the vehicle 2102. In some implementations, user voice activity detection can be performed on enhanced audio data 135 that is based on an audio signal received from interior microphones (e.g., the microphone 110 and the microphone 120), such as for a voice command from an authorized passenger. For example, the user voice activity detection can be used to detect a voice command from an operator of the vehicle 2102 (e.g., from a parent to set a volume to 5 or to set a destination for a self-driving vehicle) and to disregard the voice of another passenger (e.g., a voice command from a child to set the volume to 10 or other passengers discussing another location). In some implementations, user voice activity detection can be performed on enhanced audio data 135 that is based on an audio signal received from external microphones (e.g., the microphone 110 and the microphone 120), such as an authorized user of the vehicle. In a particular implementation, in response to receiving a verbal command identified as user speech in enhanced audio data 135 generated via operation of the audio processor 138, a voice activation system initiates one or more operations of the vehicle 2102 based on one or more keywords (e.g., “unlock,” “start engine,” “play music,” “display weather forecast,” or another voice command) detected in the enhanced audio data 135, such as by providing feedback or information via a display 2120 or one or more speakers (e.g., a speaker 2110).

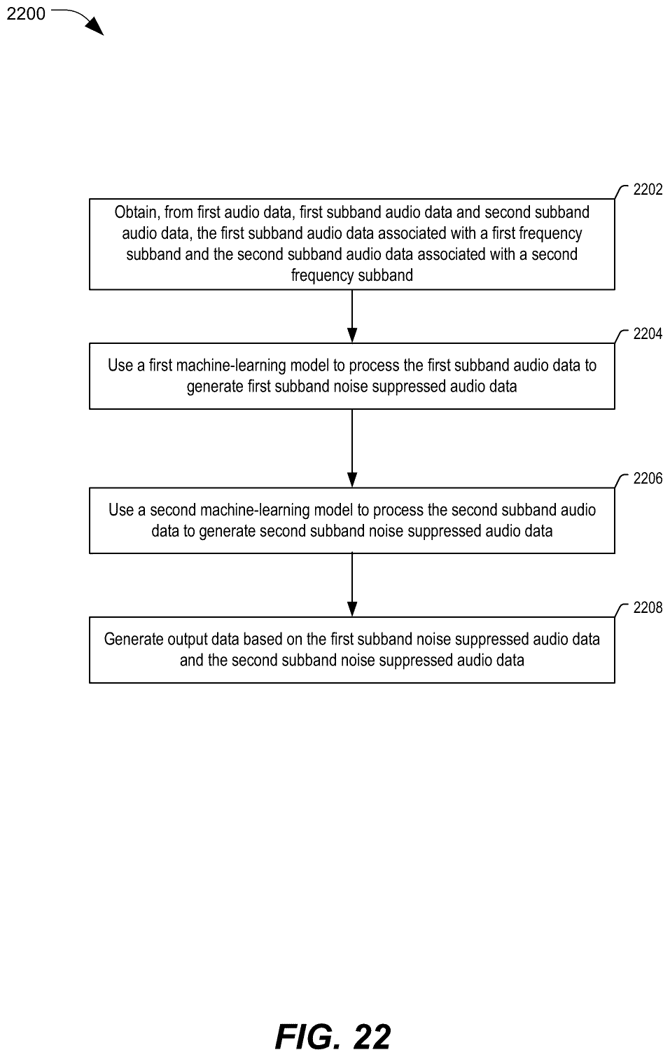

Referring to FIG. 22, a particular implementation of a method 2200 of machine-learning based audio subband processing is shown. In a particular aspect, one or more operations of the method 2200 are performed by at least one of the audio frequency splitter 142, the audio subband enhancers 144, the enhanced subband audio generator 140, the combiner 148, the audio enhancer 134, the audio processor 138, the one or more processors 190, the device 102, the system 100 of FIG. 1, the system 200 of FIG. 2, the system 400 of FIG. 4A, the system 500 of FIG. 5, the system 600 of FIG. 6A, the system 660 of FIG. 6B, the LSTMs 704A-D, the LSTMs 706A-D, the LSTMs 708A-D, the concatenation layer 748A, the concatenation layer 748B, the fully connected layer 750A, the fully connected layer 750B of FIG. 7, or a combination thereof.

The method 2200 includes, at 2202, obtaining, from first audio data, first subband audio data and second subband audio data, the first subband audio data associated with a first frequency subband and the second subband audio data associated with a second frequency subband. For example, the audio frequency splitter 142 of FIG. 1 obtains, from the audio data 117, the subband audio data 118A and the subband audio data 118B. The subband audio data 118A is associated with a first frequency subband and the subband audio data 118B is associated with a second frequency subband. As another example, an audio frequency splitter 142 of the enhanced subband audio generator 140L of FIG. 4A obtains, from the audio data 117L, subband audio data 118A and subband audio data 118B of the audio data 117L. The subband audio data 118A of the audio data 117L is associated with a first frequency subband, and the subband audio data 118B of the audio data 117L is associated with a second frequency subband.

The method 2200 also includes, at 2204, using a first machine-learning model to process the first subband audio data to generate first subband noise suppressed audio data. For example, the enhanced subband audio generator 140 of FIG. 1 uses the audio subband enhancer 144A to process at least the subband audio data 118A to generate the enhanced subband audio data 136A. In a particular aspect, the enhanced subband audio data 136A corresponds to noise suppressed audio. As another example, the enhanced subband audio generator 140L of FIG. 4A uses an audio subband enhancer 144A to process at least the subband audio data 118A of the audio data 117L to generate the enhanced subband audio data 136LA.

The method 2200 further includes, at 2206, using a second machine-learning model to process the second subband audio data to generate second subband noise suppressed audio data. For example, the enhanced subband audio generator 140 of FIG. 1 uses the audio subband enhancer 144B to process at least the subband audio data 118B to generate the enhanced subband audio data 136B. In a particular aspect, the enhanced subband audio data 136B corresponds to noise suppressed audio. As another example, the enhanced subband audio generator 140L of FIG. 4A uses an audio subband enhancer 144B to process at least the subband audio data 118B of the audio data 117L to generate the enhanced subband audio data 136LB. In a particular aspect, the enhanced subband audio data 136LB corresponds to noise suppressed audio.

The method 2200 also includes, at 2208, generating output data based on the first subband noise suppressed audio data and the second subband noise suppressed audio data. For example, the audio enhancer 134 generates the enhanced audio data 135 as output data based on the enhanced subband audio data 136A and the enhanced subband audio data 136B. As another example, the audio enhancer 134 generates the enhanced audio data 135 as output data based on the enhanced subband audio data 136LA and the enhanced subband audio data 136LB.

In some aspects, the first machine-learning model (e.g., the audio subband enhancer 144A) has first model weights that are distinct from second model weights of the second machine-learning model (e.g., the audio subband enhancer 144B). In some aspects, the first machine-learning model has a first model architecture that is distinct from a second model architecture of the second machine-learning model. A model architecture includes a count of layers, a count of nodes, a node type, a layer type, or a combination thereof. In a particular optional embodiment, the first machine-learning model (e.g., the audio subband enhancer 144A) includes a long short-term memory network (LSTM), and the second machine-learning model (e.g., the audio subband enhancer 144B) includes a convolutional neural network.

In a particular optional embodiment, the method 2200 includes obtaining a context indicator (e.g., the context indicator 328) associated with the first audio data, and obtaining first model parameters of the first machine-learning model (e.g., the audio subband enhancer 144A) based on the context indicator, as described with reference to FIG. 3. For example, the audio processor 138 obtains first model parameters of the audio subband enhancer 144A from the device 302 responsive to sending the context indicator 328 to the device 302.

In a particular optional embodiment, the method 2200 includes obtaining a context indicator (e.g., the context indicator 328) associated with the first audio data, and obtaining, based on the context indicator, the first machine-learning model (e.g., the audio subband enhancer 144A) to process the first subband audio data, as described with reference to FIG. 3. For example, the audio processor 138 obtains the audio subband enhancer 144A from the device 302 responsive to sending the context indicator 328 to the device 302.

In a particular optional embodiment, the method 2200 includes using the audio subband enhancer 144C to perform procedural signal processing to process third subband audio data (e.g., the subband audio data 118C, the subband audio data 128C, or both) to generate third subband noise suppressed audio data (e.g., the enhanced subband audio data 136C). The output data (e.g., the enhanced audio data 135, the output 146, or both) is further based on the third subband noise suppressed audio data.

In a particular optional embodiment, the method 2200 includes sending the second subband audio data (e.g., the subband audio data 118B, the subband audio data 128B, or both) to a second device (e.g., the device 202) that includes the second machine-learning model, and receiving the second subband noise suppressed audio data (e.g., the enhanced subband audio data 136B) from the second device.

In a particular optional embodiment, the method 2200 includes obtaining, from second audio data (e.g., the audio data 117R), third subband audio data (e.g., the subband audio data 118A from the audio data 117R) and fourth subband audio data (e.g., the subband audio data 118B from the audio data 117R). The third subband audio data is associated with the first frequency subband and the fourth subband audio data is associated with the second frequency subband. The method 2200 also includes using a third machine-learning model (e.g., an audio subband enhancer 144A of the enhanced subband audio generator 140R) to process the third subband audio data to generate third subband noise suppressed audio data (e.g., the enhanced subband audio data 136RA). The method 2200 further includes using a fourth machine-learning model (e.g., an audio subband enhancer 144B of the enhanced subband audio generator 140R) to process the fourth subband audio data to generate fourth subband noise suppressed audio data (e.g., the enhanced subband audio data 136RB). The method 2200 also includes determining first subband intermediate audio data (e.g., the enhanced subband audio data 136A) based on the first subband noise suppressed audio data (e.g., the enhanced subband audio data 136LA), the third subband noise suppressed audio data (e.g., the enhanced subband audio data 136RA), or both. The method 2200 further includes determining second subband intermediate audio data (e.g., the enhanced subband audio data 136B) based on the second subband noise suppressed audio data (e.g., the enhanced subband audio data 136LB), the fourth subband noise suppressed audio data (e.g., the enhanced subband audio data 136RB), or both. The output data (e.g., the enhanced audio data 135, the output 146, or both) is based on the first subband intermediate audio data and the second subband intermediate audio data.

In a particular optional embodiment, the method 2200 includes selecting one of the first subband noise suppressed audio data (e.g., the enhanced subband audio data 136LA) or the third subband noise suppressed audio data (e.g., the enhanced subband audio data 136RA) as the first subband intermediate audio data (e.g., the enhanced subband audio data 136A).

In a particular optional embodiment, the method 2200 includes generating a first sound metric of the first subband noise suppressed audio data (e.g., the enhanced subband audio data 136LA). The method 2200 also includes generating a third sound metric of the third subband noise suppressed audio data (e.g., the enhanced subband audio data 136RA). The method 2200 further includes, based on a comparison of the first sound metric and the third sound metric, selecting one of the first subband noise suppressed audio data or the third subband noise suppressed audio data as the first subband intermediate audio data (e.g., the enhanced subband audio data 136A).

In a particular optional embodiment, a sound metric includes a signal-to-noise ratio (SNR). In a particular optional embodiment, a sound metric includes a speech quality metric, a speech intelligibility metric, or both.

In a particular optional embodiment, the method 2200 includes generating the first subband intermediate audio data (e.g., the enhanced subband audio data 136A) based on a weighted combination of the first subband noise suppressed audio data (e.g., the enhanced subband audio data 136LA) and the third subband noise suppressed audio data (e.g., the enhanced subband audio data 136RA).

In a particular optional embodiment, the first audio data is received from a first microphone (e.g., the microphone 110, the microphone 110L, or the microphone 120L), and wherein the second audio data is received from a second microphone (e.g., the microphone 120, the microphone 110R, or the microphone 120R).

In a particular optional embodiment, the method 2200 includes using the first microphone to capture first sounds of an audio environment to generate the first audio data. The method 2200 also includes using the second microphone to capture second sounds of the audio environment to generate the second audio data.

The method 2200 enables audio enhancement (e.g., noise suppression) that is targeted to per subband resulting improved audio quality as compared to across frequency band audio enhancement. Separate machine-learning models that are trained to process different subbands can have lower complexity (e.g., fewer network nodes, network layers, etc.) and higher efficiency (e.g., faster processing time, fewer computing cycles, etc.) as compared to a single machine-learning model that is trained to process a larger frequency band that includes the subbands.

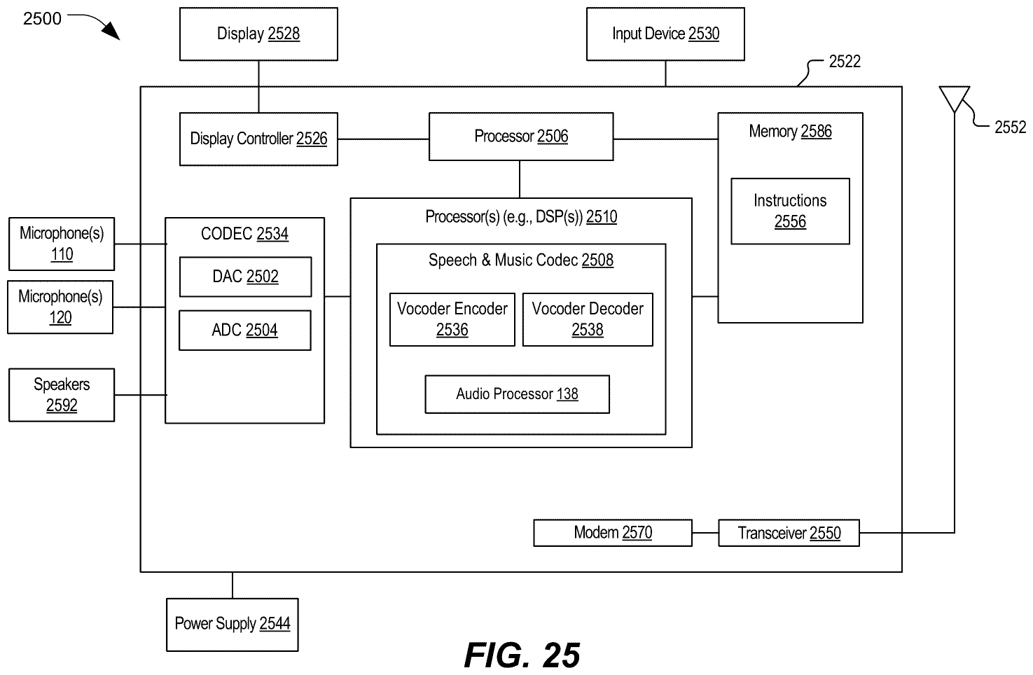

The method 2200 of FIG. 22 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 2200 of FIG. 22 may be performed by a processor that executes instructions, such as described with reference to FIG. 25.

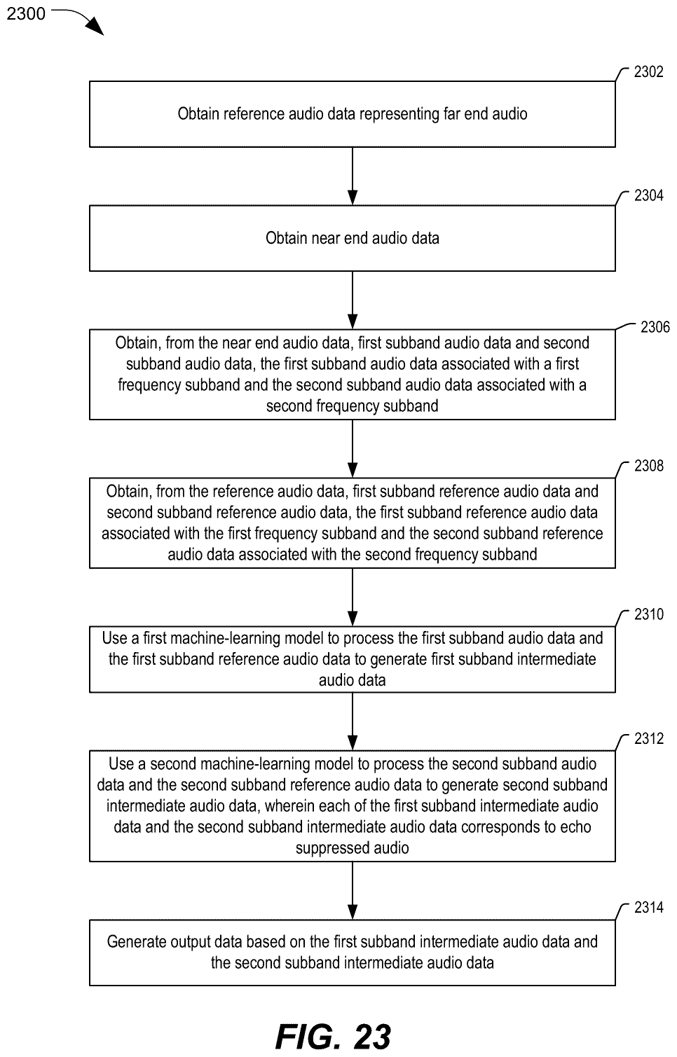

Referring to FIG. 23, a particular implementation of a method 2300 of machine-learning based audio subband processing is shown. In a particular aspect, one or more operations of the method 2300 are performed by at least one of the audio frequency splitter 142, the audio subband enhancers 144, the enhanced subband audio generator 140, the combiner 148, the audio enhancer 134, the audio processor 138, the one or more processors 190, the device 102, the system 100 of FIG. 1, the system 200 of FIG. 2, the system 400 of FIG. 4A, the system 500 of FIG. 5, the system 600 of FIG. 6A, the system 660 of FIG. 6B, the LSTMs 704A-D, the LSTMs 706A-D, the LSTMs 708A-D, the concatenation layer 748A, the concatenation layer 748B, the fully connected layer 750A, the fully connected layer 750B of FIG. 7, or a combination thereof.

The method 2300 includes, at 2302, obtaining reference audio data representing far end audio. For example, the audio enhancer 134 of FIG. 1 obtains the audio data 127. In a particular aspect, the audio data 127 corresponds to reference audio data representing far end audio. To illustrate, the device 102 receives the audio data 126 or the audio data 127 from another device during a call.

The method 2300 also includes, at 2304, obtaining near end audio data. For example, the audio enhancer 134 of FIG. 1 obtains the audio data 117. In a particular aspect, the audio data 117 corresponds to near end audio data. To illustrate, the device 102 receives the audio data 116 or the audio data 117 from the microphone 110 coupled to the device 102.

The method 2300 further includes, at 2306, obtaining, from the near end audio data, first subband audio data and second subband audio data, the first subband audio data associated with a first frequency subband and the second subband audio data associated with a second frequency subband. For example, the audio frequency splitter 142 of FIG. 1 obtains, from the audio data 117, the subband audio data 118A and the subband audio data 118B. The subband audio data 118A is associated with a first frequency subband and the subband audio data 118B is associated with a second frequency subband.

The method 2300 also includes, at 2308, obtaining, from the reference audio data, first subband reference audio data and second subband reference audio data, the first subband reference audio data associated with the first frequency subband and the second subband reference audio data associated with the second frequency subband. For example, the audio frequency splitter 142 of FIG. 1 obtains, from the audio data 127, the subband audio data 128A and the subband audio data 128B. The subband audio data 128A is associated with the first frequency subband and the subband audio data 128B is associated with the second frequency subband.

The method 2300 also includes, at 2310, using a first machine-learning model to process the first subband audio data and the first subband reference audio data to generate first subband intermediate audio data. For example, the enhanced subband audio generator 140 of FIG. 1 uses the audio subband enhancer 144A (e.g., a first machine-learning model) to process the subband audio data 118A and the subband audio data 128A to generate the enhanced subband audio data 136A as first subband intermediate audio data.

The method 2300 also includes, at 2312, using a second machine-learning model to process the second subband audio data and the second subband reference audio data to generate second subband intermediate audio data, wherein each of the first subband intermediate audio data and the second subband intermediate audio data corresponds to echo suppressed audio. For example, the enhanced subband audio generator 140 of FIG. 1 uses the audio subband enhancer 144B (e.g., a second machine-learning model) to process the subband audio data 118B and the subband audio data 128B to generate the enhanced subband audio data 136B as second subband intermediate audio data. The enhanced subband audio data 136A and the enhanced subband audio data 136B correspond to audio enhanced (e.g., echo suppressed) audio.

The method 2300 also includes, at 2314, generating output data based on the first subband intermediate audio data and the second subband intermediate audio data. For example, the audio enhancer 134 of FIG. 1 generates the enhanced audio data 135 as output data based on the enhanced subband audio data 136A and the enhanced subband audio data 136B. In a particular optional embodiment, each of the first subband intermediate audio data (e.g., the enhanced subband audio data 136A) and the second subband intermediate audio data (e.g., the enhanced subband audio data 136B) corresponds to noise suppressed audio. In a particular optional embodiment, the first machine-learning model (e.g., the audio subband enhancer 144A) includes a long short-term memory network (LSTM), and wherein the second machine-learning model (e.g., the audio subband enhancer 144B) includes a convolutional neural network.

In a particular optional embodiment, the first machine-learning model (e.g., the audio subband enhancer 144A) has first model weights that are distinct from second model weights of the second machine-learning model (e.g., the audio subband enhancer 144B). In a particular optional embodiment, the first machine-learning model (e.g., the audio subband enhancer 144A) has a first model architecture that is distinct from a second model architecture of the second machine-learning model (e.g., the audio subband enhancer 144B). A model architecture includes a count of layers, a count of nodes, a node type, a layer type, or a combination thereof.

The method 2300 enables targeted audio enhancement (e.g., noise suppression) on a per-subband basis resulting in improved overall audio quality as compared to across frequency band audio enhancement. Separate machine-learning models that are trained to process different subbands can have lower complexity (e.g., fewer network nodes, network layers, etc.) and higher efficiency (e.g., faster processing time, fewer computing cycles, etc.) as compared to a single machine-learning model that is trained to process a larger frequency band that includes the subbands.

The method 2300 of FIG. 23 may be implemented by an FPGA device, an ASIC, a processing unit such as a CPU, a DSP, a controller, another hardware device, firmware device, or any combination thereof. As an example, the method 2300 of FIG. 23 may be performed by a processor that executes instructions, such as described with reference to FIG. 25.

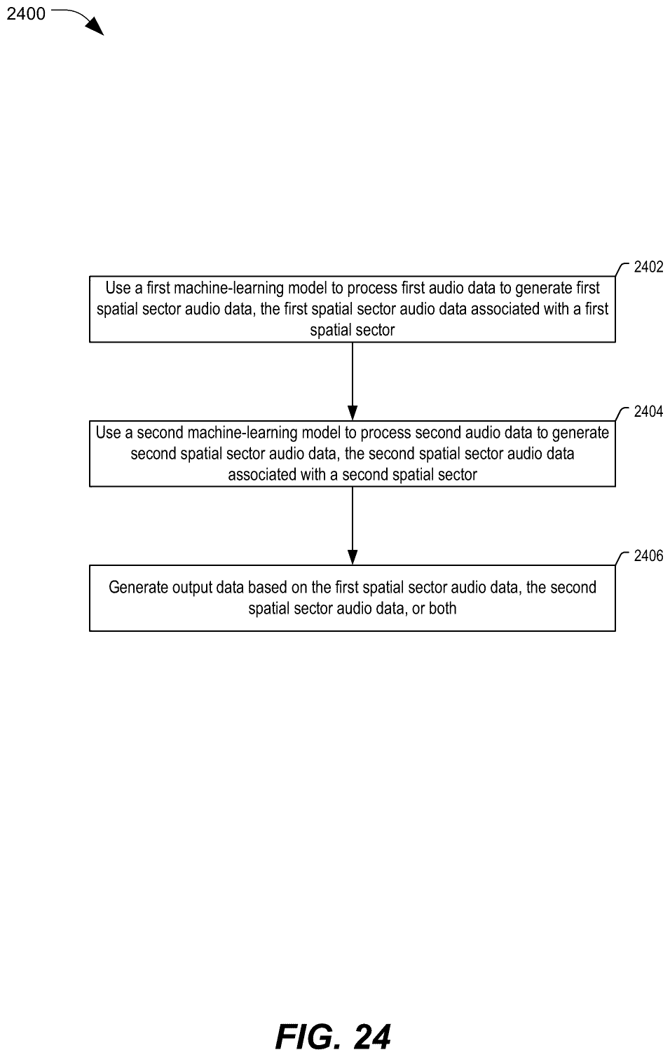

Referring to FIG. 24, a particular implementation of a method 2400 of machine-learning based audio subband processing is shown. In a particular aspect, one or more operations of the method 2400 are performed by at least one of the audio frequency splitter 142, the audio subband enhancers 144, the enhanced subband audio generator 140, the combiner 148, the audio enhancer 134, the audio processor 138, the one or more processors 190, the device 102, the system 100 of FIG. 1, the system 200 of FIG. 2, the system 400 of FIG. 4A, the system 500 of FIG. 5, the system 600 of FIG. 6A, the system 660 of FIG. 6B, the LSTMs 704A-D, the LSTMs 706A-D, the LSTMs 708A-D, the concatenation layer 748A, the concatenation layer 748B, the fully connected layer 750A, the fully connected layer 750B of FIG. 7, or a combination thereof.

The method 2400 includes, at 2402, using a first machine-learning model to process first audio data to generate first spatial sector audio data, the first spatial sector audio data associated with a first spatial sector. For example, the spatial sector audio extractor 640 of FIG. 6A uses a first machine-learning model to process the audio data 117 to generate the sector audio data 617A associated with the sector 654A. As another example, the audio enhancer 134 of FIG. 6A uses the audio enhancer 134A to process at least the sector audio data 617A to generate the enhanced audio data 135A associated with the sector 654A. The audio enhancer 134A includes one or more machine-learning models (e.g., audio subband enhancers 144).

The method 2400 also includes, at 2404, using a second machine-learning model to process second audio data to generate second spatial sector audio data, the second spatial sector audio data associated with a second spatial sector. For example, the spatial sector audio extractor 640 uses a second machine-learning model to process the audio data 127 to generate the sector audio data 627B associated with the sector 654B. As another example, the audio enhancer 134 of FIG. 6A uses the audio enhancer 134B to process at least the sector audio data 617B to generate the enhanced audio data 135B associated with the sector 654B. The audio enhancer 134B includes one or more machine-learning models (e.g., audio subband enhancers 144).

The method 2400 further includes, at 2406, generating output data based on the first spatial sector audio data, the second spatial sector audio data, or both. For example, the audio enhancer 134 generates the enhanced audio data 135 based on the sector audio data 617A, the sector audio data 627B, or both. As another example, the audio enhancer 134 generates the enhanced audio data 135 based on the selected spatial audio data 646 that is based on the enhanced audio data 135A, the enhanced audio data 135B, or both, as described with reference to FIG. 6A.

In a particular optional embodiment, the method 2400 includes generating a first sound metric of the first spatial sector audio data (e.g., the enhanced audio data 135A). The method 2400 also includes generating a second sound metric of the second spatial sector audio data (e.g., the enhanced audio data 135B). The method 2400 further includes, based on a comparison of the first sound metric and the second sound metric, selecting one of the first spatial sector audio data or the second spatial sector audio data as the output data (e.g., the selected spatial audio data 646).

In a particular optional embodiment, a sound metric includes a signal-to-noise ratio (SNR). In a particular optional embodiment, a sound metric includes a speech quality metric, a speech intelligibility metric, or both.

In a particular optional embodiment, the method 2400 includes generating the output data based on sensor input (e.g., the sensor input 312) from a sensor (e.g., the one or more sensors 310). In a particular optional embodiment, the method 2400 includes selecting, based on the sensor input, one of the first spatial sector audio data (e.g., the enhanced audio data 135A) or the second spatial sector audio data (e.g., the enhanced audio data 135B) as the output data (e.g., the selected spatial audio data 646).

In a particular optional embodiment, the method 2400 includes selecting, based on the sensor input, the first spatial sector (e.g., the sector 654A) and the second spatial sector (e.g., the sector 654B). The method 2400 also includes, responsive to selection of the first spatial sector, using the first machine-learning model (e.g., a first machine-learning model of the spatial sector audio extractor 640 or the audio enhancer 134A) to generate the first spatial sector audio data (e.g., the sector audio data 617A or the enhanced audio data 135A). The method 2400 further includes, responsive to selection of the second spatial sector, using the second machine-learning model (e.g., a second machine-learning model of the spatial sector audio extractor 640 or the audio enhancer 134B) to generate the second spatial sector audio data (e.g., the sector audio data 617B or the enhanced audio data 135B).

In a particular optional embodiment, the sensor (e.g., the one or more sensors 310) includes a gyroscope, a camera, a microphone, or a combination thereof, and the sensor input (e.g., the sensor input 312) indicates a phone orientation, a detected sound source, a detected occlusion, or a combination thereof.

In a particular optional embodiment, the method 2400 includes, based on sensor input (e.g., the sensor input 312) indicating that a first sound source (e.g., the sound source 180) is detected in the first spatial sector (e.g., the sector 654A) and a second sound source (e.g., the sound source 184A) is detected in the second spatial sector (e.g., the sector 654B), performing noise suppression on the first spatial sector audio data (e.g., the sector audio data 617A, the sector audio data 627A, or both) based on the second spatial sector audio data (e.g., the sector audio data 617B, the sector audio data 627B, or both) to generate the output data (e.g., the enhanced audio data 135).

In a particular optional embodiment, the method 2400 includes obtaining, from the first spatial sector audio data (e.g., the sector audio data 617A or the sector audio data 627A), first spatial sector first subband audio data (e.g., the sector subband audio data 618AA or the sector subband audio data 628AA) and first spatial sector second subband audio data (e.g., the sector subband audio data 618AB or the sector subband audio data 628AB). The method 2400 also includes obtaining, from the second spatial sector audio data (e.g., the sector audio data 617B or the sector audio data 627B), second spatial sector first subband audio data (e.g., the sector subband audio data 618BA or the sector subband audio data 628BA) and second spatial sector second subband audio data (e.g., the sector subband audio data 618BB or the sector subband audio data 628BB). The method 2400 further includes performing noise suppression on the first spatial sector first subband audio data (e.g., the sector subband audio data 618AA or the sector subband audio data 628AA) based on second spatial sector first subband audio data (e.g., the sector subband audio data 618BA or the sector subband audio data 628BA) to generate first subband noise suppressed audio data (e.g., the enhanced audio data 135A). The method 2400 also includes performing noise suppression on the first spatial sector second subband audio data (e.g., the sector subband audio data 618AB or the sector subband audio data 628AB) based on second spatial sector second subband audio data (e.g., the sector subband audio data 618BB or the sector subband audio data 628BB) to generate second subband noise suppressed audio data (e.g., the enhanced audio data 135B). The method 2400 further includes generating the output data (e.g., the enhanced audio data 135) based on the first subband noise suppressed audio data (e.g., the enhanced audio data 135A) and the second subband noise suppressed audio data (e.g., the enhanced audio data 135B).

In a particular optional embodiment, the method 2400 includes receiving the first audio data and the second audio data from a microphone array. In a particular optional embodiment, the first audio data is received from a first subset of the microphone array, and the second audio data is received from a second subset of the microphone array. In a particular optional embodiment, the method 2400 includes using a beamformer to process the audio data to generate the first audio data and the second audio data.

The method 2400 enables targeted audio enhancement (e.g., noise suppression) on a per-subband basis resulting in improved overall audio quality as compared to across frequency band audio enhancement. Separate machine-learning models that are trained to process different subbands can have lower complexity (e.g., fewer network nodes, network layers, etc.) and higher efficiency (e.g., faster processing time, fewer computing cycles, etc.) as compared to a single machine-learning model that is trained to process a larger frequency band that includes the subbands.

The method 2400 of FIG. 24 may be implemented by an FPGA device, an ASIC, a processing unit such as a CPU, a DSP, a controller, another hardware device, firmware device, or any combination thereof. As an example, the method 2400 of FIG. 24 may be performed by a processor that executes instructions, such as described with reference to FIG. 25.

Referring to FIG. 25, a block diagram of a particular illustrative implementation of a device is depicted and generally designated 2500. In various implementations, the device 2500 may have more or fewer components than illustrated in FIG. 25. In an illustrative implementation, the device 2500 may correspond to the device 102. In an illustrative implementation, the device 2500 may perform one or more operations described with reference to FIGS. 1-24.

In a particular implementation, the device 2500 includes a processor 2506 (e.g., a CPU). The device 2500 may include one or more additional processors 2510 (e.g., one or more DSPs). In a particular aspect, the one or more processors 190 of FIG. 1 correspond to the processor 2506, the processors 2510, or a combination thereof. The processors 2510 may include a speech and music coder-decoder (CODEC) 2508 that includes a voice coder (“vocoder”) encoder 2536, a vocoder decoder 2538, the audio processor 138, or a combination thereof.

The device 2500 may include a memory 2586 and a CODEC 2534. The memory 2586 may include instructions 2556, that are executable by the one or more additional processors 2510 (or the processor 2506) to implement the functionality described with reference to one or more components of the audio processor 138. The device 2500 may include a modem 2570 coupled, via a transceiver 2550, to an antenna 2552.

The device 2500 may include a display 2528 coupled to a display controller 2526. A speaker 2592, the microphone 110, the microphone 120, one or more additional microphones, or a combination thereof, may be coupled to the CODEC 2534. The CODEC 2534 may include a digital-to-analog converter (DAC) 2502, an analog-to-digital converter (ADC) 2504, or both. In a particular implementation, the CODEC 2534 may receive analog signals from the microphone 110 and the microphone 120, convert the analog signals to digital signals using the analog-to-digital converter 2504, and provide the digital signals to the speech and music codec 2508. The speech and music codec 2508 may process the digital signals, and the digital signals may further be processed by the audio processor 138. In a particular implementation, the speech and music codec 2508 may provide digital signals to the CODEC 2534. The CODEC 2534 may convert the digital signals to analog signals using the digital-to-analog converter 2502 and may provide the analog signals to the speaker 2592.

In a particular implementation, the device 2500 may be included in a system-in-package or system-on-chip device 2522. In a particular implementation, the memory 2586, the processor 2506, the processors 2510, the display controller 2526, the CODEC 2534, and the modem 2570 are included in the system-in-package or system-on-chip device 2522. In a particular implementation, an input device 2530 and a power supply 2544 are coupled to the system-in-package or the system-on-chip device 2522. Moreover, in a particular implementation, as illustrated in FIG. 25, the display 2528, the input device 2530, the speaker 2592, the microphone 110, the microphone 120, the antenna 2552, and the power supply 2544 are external to the system-in-package or the system-on-chip device 2522. In a particular implementation, each of the display 2528, the input device 2530, the speaker 2592, the microphone 110, the microphone 120, the antenna 2552, and the power supply 2544 may be coupled to a component of the system-in-package or the system-on-chip device 2522, such as an interface (e.g., the input interface 114 or the input interface 124) or a controller.

The device 2500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described embodiments, an apparatus includes means for obtaining first subband audio data and second subband audio data from first audio data, the first subband audio data associated with a first frequency subband and the second subband audio data associated with a second frequency subband. For example, the means for obtaining the first subband audio data and the second subband audio data can include the audio frequency splitter 142, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the processor 2506, the processor(s) 2510, one or more other circuits or components configured to obtain the first subband audio data and the second subband audio data, or any combination thereof.

The apparatus also includes means for using a first machine-learning model to process the first subband audio data to generate first subband noise suppressed audio data. For example, the means for using the first machine-learning model can include the audio subband enhancer 144A, the audio subband enhancers 144, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the LSTM 704A, the LSTM 706A, the LSTM 708A of FIG. 7, the processor 2506, the processor(s) 2510, one or more other circuits or components configured to use a first machine-learning model to process first subband audio data, or any combination thereof.

The apparatus further includes means for using a second machine-learning model to process the second subband audio data to generate second subband noise suppressed audio data. For example, the means for using the second machine-learning model can include the audio subband enhancer 144B, the audio subband enhancers 144, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the LSTM 704B, the LSTM 706B, the LSTM 708B of FIG. 7, the processor 2506, the processor(s) 2510, one or more other circuits or components configured to use a second machine-learning model to process second subband audio data, or any combination thereof.

The apparatus also includes means for generating output data based on the first subband noise suppressed audio data and the second subband noise suppressed audio data. For example, the means for generating the output data can include the combiner 148, the audio enhancer 134, the audio processor 138, the one or more processors 190, the device 102, the system 100 of FIG. 1, the device 202, the system 200 of FIG. 2, the subband selector 440A, the subband selector 440B, the subband selector 440C, the system 400 of FIG. 4A, the system 500 of FIG. 5, the spatial output selector 634, the system 600 of FIG. 6A, the system 660 of FIG. 6B, the concatenation layer 748A, the concatenation layer 748B, the fully connected layer 750A, the fully connected layer 750B, the sigmoid function 752, the multiplier 754 of FIG. 7, the processor 2506, the processor(s) 2510, one or more other circuits or components configured to generate the output data, or any combination thereof.

Also in conjunction with the described embodiments, an apparatus includes means for obtaining reference audio data representing far end audio. For example, the means for obtaining the reference audio data can include the audio frequency splitter 142, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the spatial sector audio extractor 640, the audio enhancer 134A, the audio enhancer 134B, the audio enhancer 134C, the audio enhancer 134D, the system 600 of FIG. 6A, the system 660 of FIG. 6B, the delay 740 of FIG. 7, the modem 2570, the transceiver 2550, the antenna 2552, the processor 2506, the processor(s) 2510, one or more other circuits or components configured to obtain the reference audio data, or any combination thereof.

The apparatus also includes means for obtaining near end audio data. For example, the means for obtaining the near end audio data can include the microphone 110, the input interface 114, the audio frequency splitter 142, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the spatial sector audio extractor 640, the audio enhancer 134A, the audio enhancer 134B, the audio enhancer 134C, the audio enhancer 134D, the system 600 of FIG. 6A, the system 660 of FIG. 6B, the delay 740 of FIG. 7, the processor 2506, the processor(s) 2510, one or more other circuits or components configured to obtain the near end audio data, or any combination thereof.

The apparatus further includes means for obtaining first subband audio data and second subband audio data from the near end audio data, the first subband audio data associated with a first frequency subband and the second subband audio data associated with a second frequency subband. For example, the means for obtaining the first subband audio data and the second subband audio data can include the audio frequency splitter 142, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the processor 2506, the processor(s) 2510, one or more other circuits or components configured to obtain the first subband audio data and the second subband audio data, or any combination thereof.

The apparatus also includes means for obtaining first subband reference audio data and second subband reference audio data from the reference audio data, the first subband reference audio data associated with the first frequency subband and the second subband reference audio data associated with the second frequency subband. For example, the means for obtaining the first subband reference audio data and the second subband reference audio data can include the audio frequency splitter 142, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the processor 2506, the processor(s) 2510, one or more other circuits or components configured to obtain the first subband reference audio data and the second subband reference audio data, or any combination thereof.

The apparatus further includes means for using a first machine-learning model to process the first subband audio data and the first subband reference audio data to generate first subband intermediate audio data. For example, the means for using the first machine-learning model can include the audio subband enhancer 144A, the audio subband enhancers 144, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the LSTM 704A, the LSTM 706A, the LSTM 708A of FIG. 7, the processor 2506, the processor(s) 2510, one or more other circuits or components configured to use a first machine-learning model to process first subband audio data and the first subband reference audio data, or any combination thereof.

The apparatus also includes means for using a second machine-learning model to process the second subband audio data and the second subband reference audio data to generate second subband intermediate audio data, where each of the first subband intermediate audio data and the second subband intermediate audio data corresponds to echo suppressed audio. For example, the means for using the second machine-learning model can include the audio subband enhancer 144B, the audio subband enhancers 144, the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4A, the system 500 of FIG. 5, the audio enhancer 134A, the audio enhancer 134B, the audio enhancer 134C, the audio enhancer 134D, the system 600 of FIG. 6A, the system 660 of FIG. 6B, the LSTM 704B, the LSTM 706B, the LSTM 708B of FIG. 7, the processor 2506, the processor(s) 2510, one or more other circuits or components configured to use a second machine-learning model to process second subband audio data and the second subband reference audio data, or any combination thereof.

The apparatus further includes means for generating output data based on the first subband intermediate audio data and the second subband intermediate audio data. For example, the means for generating the output data can include the combiner 148, the audio enhancer 134, the audio processor 138, the one or more processors 190, the device 102, the system 100 of FIG. 1, the device 202, the system 200 of FIG. 2, the subband selector 440A, the subband selector 440B, the subband selector 440C, the system 400 of FIG. 4A, the system 500 of FIG. 5, the spatial output selector 634, the system 600 of FIG. 6A, the system 660 of FIG. 6B, the concatenation layer 748A, the concatenation layer 748B, the fully connected layer 750A, the fully connected layer 750B, the sigmoid function 752, the multiplier 754 of FIG. 7, the processor 2506, the processor(s) 2510, one or more other circuits or components configured to generate the output data, or any combination thereof.

Further in conjunction with the described embodiments, an apparatus includes means for using a first machine-learning model to process first audio data to generate first spatial sector audio data, the first spatial sector audio data associated with a first spatial sector. For example, the means for using the first-machine learning model can include the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4, the system 500 of FIG. 5, the spatial sector audio extractor 640, the audio enhancer 134A, the system 600 of FIG. 6A, the system 660 of FIG. 6B, the processor 2506, the processor(s) 2510, one or more other circuits or components configured to use a first machine-learning model to process first audio data to generate first spatial sector audio data, or any combination thereof.

The apparatus also includes means for using a second machine-learning model to process second audio data to generate second spatial sector audio data, the second spatial sector audio data associated with a second spatial sector. For example, the means for using the second machine-learning model can include the enhanced subband audio generator 140, the audio enhancer 134, the audio processor 138, the one or more processors 190, the device 102, the system 100 of FIG. 1, the device 202, the system 200 of FIG. 2, the enhanced subband audio generator 140L, the enhanced subband audio generator 140R, the system 400 of FIG. 4, the system 500 of FIG. 5, the spatial sector audio extractor 640, the audio enhancer 134B, the system 600 of FIG. 6A, the system 660 of FIG. 6B, the processor 2506, the processor(s) 2510, one or more other circuits or components configured to use a second machine-learning model to process second audio data to generate second spatial sector audio data, or any combination thereof.

The apparatus further includes means for generating output data based on the first spatial sector audio data, the second spatial sector audio data, or both. For example, the means for generating the output data can include the combiner 148, the audio enhancer 134, the audio processor 138, the one or more processors 190, the device 102, the system 100 of FIG. 1, the device 202, the system 200 of FIG. 2, the subband selector 440A, the subband selector 440B, the subband selector 440C, the system 400 of FIG. 4A, the system 500 of FIG. 5, the audio enhancer 134A, the audio enhancer 134B, the audio enhancer 134C, the audio enhancer 134D, the spatial output selector 634, the system 600 of FIG. 6A, the system 660 of FIG. 6B, the concatenation layer 748A, the concatenation layer 748B, the fully connected layer 750A, the fully connected layer 750B, the sigmoid function 752, the multiplier 754 of FIG. 7, the processor 2506, the processor(s) 2510, one or more other circuits or components configured to generate the output data, or any combination thereof.

In some implementations, a non-transitory computer-readable medium (e.g., a computer-readable storage device, such as the memory 2586) includes instructions (e.g., the instructions 2556) that, when executed by one or more processors (e.g., the one or more processors 2510 or the processor 2506), cause the one or more processors to obtain, from first audio data (e.g., the audio data 117), first subband audio data (e.g., the subband audio data 118A) and second subband audio data (e.g., the subband audio data 118B), the first subband audio data associated with a first frequency subband and the second subband audio data associated with a second frequency subband. The instructions, when executed by the one or more processors, also cause the one or more processors to use a first machine-learning model (e.g., the audio subband enhancer 144A, the LSTM 704A, the LSTM 706A, or the LSTM 708A) to process the first subband audio data to generate first subband noise suppressed audio data (e.g., the enhanced subband audio data 136A). The instructions, when executed by the one or more processors, further cause the one or more processors to use a second machine-learning model (e.g., the audio subband enhancer 144B, the LSTM 704B, the LSTM 706B, or the LSTM 708B) to process the second subband audio data to generate second subband noise suppressed audio data (e.g., the enhanced subband audio data 136B). The instructions, when executed by the one or more processors, also cause the one or more processors to generate output data (e.g., the enhanced audio data 135 or the output 146) based on the first subband noise suppressed audio data and the second subband noise suppressed audio data.

In some implementations, a non-transitory computer-readable medium (e.g., a computer-readable storage device, such as the memory 2586) includes instructions (e.g., the instructions 2556) that, when executed by one or more processors (e.g., the one or more processors 2510 or the processor 2506), cause the one or more processors to obtain reference audio data (e.g., the audio data 127) representing far end audio and to obtain near end audio data (e.g., the audio data 117). The instructions, when executed by the one or more processors, also cause the one or more processors to obtain, from the near end audio data, first subband audio data (e.g., the subband audio data 118A) and second subband audio data (e.g., the subband audio data 118B). The first subband audio data is associated with a first frequency subband and the second subband audio data is associated with a second frequency subband. The instructions, when executed by the one or more processors, further cause the one or more processors to obtain, from the reference audio data, first subband reference audio data (e.g., the subband audio data 128A) and second subband reference audio data (e.g., the subband audio data 128B). The first subband reference audio data associated with the first frequency subband and the second subband reference audio data associated with the second frequency subband. The instructions, when executed by the one or more processors, also cause the one or more processors to use a first machine-learning model (e.g., the audio subband enhancer 144A, the LSTM 704A, the LSTM 706A, or the LSTM 708A) to process the first subband audio data and the first subband reference audio data to generate first subband intermediate audio data (e.g., the enhanced subband audio data 136A). The instructions, when executed by the one or more processors, further cause the one or more processors to use a second machine-learning model (e.g., the audio subband enhancer 144B, the LSTM 704B, the LSTM 706B, or the LSTM 708B) to process the second subband audio data and the second subband reference audio data to generate second subband intermediate audio data (e.g., the enhanced subband audio data 136B). Each of the first subband intermediate audio data and the second subband intermediate audio data corresponds to echo suppressed audio. The instructions, when executed by the one or more processors, also cause the one or more processors to generate output data (e.g., the enhanced audio data 135 or the output 146) based on the first subband intermediate audio data and the second subband intermediate audio data.

In some implementations, a non-transitory computer-readable medium (e.g., a computer-readable storage device, such as the memory 2586) includes instructions (e.g., the instructions 2556) that, when executed by one or more processors (e.g., the one or more processors 2510 or the processor 2506), cause the one or more processors to use a first machine-learning model (e.g., of the spatial sector audio extractor 640) to process first audio data (e.g., the audio data 117) to generate first spatial sector audio data (e.g., the sector audio data 617A). The first spatial sector audio data is associated with a first spatial sector (e.g., the sector 654A). The instructions, when executed by the one or more processors, also cause the one or more processors to use a second machine-learning model (e.g., of the spatial sector audio extractor 640) to process second audio data (e.g., the audio data 117 or the audio data 127) to generate second spatial sector audio data (e.g., the sector audio data 617B or the sector audio data 627B). The second spatial sector audio data is associated with a second spatial sector (e.g., the sector 654B). The instructions, when executed by the one or more processors, further cause the one or more processors to generate output data (e.g., the selected spatial audio data 646, the enhanced audio data 135, or the output 146) based on the first spatial sector audio data, the second spatial sector audio data, or both.

Particular aspects of the disclosure are described below in sets of interrelated Examples:

According to Example 1, a device includes a memory configured to store audio data; and one or more processors configured to obtain, from first audio data, first subband audio data and second subband audio data, the first subband audio data associated with a first frequency subband and the second subband audio data associated with a second frequency subband; use a first machine-learning model to process the first subband audio data to generate first subband noise suppressed audio data; use a second machine-learning model to process the second subband audio data to generate second subband noise suppressed audio data; and generate output data based on the first subband noise suppressed audio data and the second subband noise suppressed audio data.

Example 2 includes the device of Example 1, wherein the first machine-learning model has first model weights that are distinct from second model weights of the second machine-learning model.

Example 3 includes the device of Example 1 or Example 2, wherein the first machine-learning model has a first model architecture that is distinct from a second model architecture of the second machine-learning model, wherein a model architecture includes a count of layers, a count of nodes, a node type, a layer type, or a combination thereof.

Example 4 includes the device of any of Examples 1 to 3, wherein the first machine-learning model includes a long short-term memory network (LSTM), and wherein the second machine-learning model includes a convolutional neural network.

Example 5 includes the device of any of Examples 1 to 4, wherein the one or more processors are configured to obtain a context indicator associated with the first audio data; and obtain first model parameters of the first machine-learning model based on the context indicator.

Example 6 includes the device of any of Examples 1 to 5, wherein the one or more processors are configured to obtain a context indicator associated with the first audio data; and obtain, based on the context indicator, the first machine-learning model to process the first subband audio data.

Example 7 includes the device of any of Examples 1 to 6, wherein the one or more processors are configured to, use procedural signal processing to process third subband audio data to generate third subband noise suppressed audio data, wherein the output data is further based on the third subband noise suppressed audio data.

Example 8 includes the device of any of Examples 1 to 7, wherein the one or more processors are configured to send the second subband audio data to a second device that includes the second machine-learning model; and receive the second subband noise suppressed audio data from the second device.

Example 9 includes the device of any of Examples 1 to 8, wherein the one or more processors configured to obtain, from second audio data, third subband audio data and fourth subband audio data, the third subband audio data associated with the first frequency subband and the fourth subband audio data associated with the second frequency subband; use a third machine-learning model to process the third subband audio data to generate third subband noise suppressed audio data; use a fourth machine-learning model to process the fourth subband audio data to generate fourth subband noise suppressed audio data; determine first subband intermediate audio data based on the first subband noise suppressed audio data, the third subband noise suppressed audio data, or both; and determine second subband intermediate audio data based on the second subband noise suppressed audio data, the fourth subband noise suppressed audio data, or both, wherein the output data is based on the first subband intermediate audio data and the second subband intermediate audio data.

Example 10 includes the device of Example 9, wherein the one or more processors are configured to select one of the first subband noise suppressed audio data or the third subband noise suppressed audio data as the first subband intermediate audio data.

Example 11 includes the device of Example 9 or Example 10, wherein the one or more processors are configured to generate a first sound metric of the first subband noise suppressed audio data; generate a third sound metric of the third subband noise suppressed audio data; and based on a comparison of the first sound metric and the third sound metric, select one of the first subband noise suppressed audio data or the third subband noise suppressed audio data as the first subband intermediate audio data.

Example 12 includes the device of Example 11, wherein a sound metric includes a signal-to-noise ratio (SNR).

Example 13 includes the device of Example 11 or Example 12, wherein a sound metric includes a speech quality metric, a speech intelligibility metric, or both.

Example 14 includes the device of Example 9, wherein the one or more processors are configured generate the first subband intermediate audio data based on a weighted combination of the first subband noise suppressed audio data and the third subband noise suppressed audio data.

Example 15 includes the device of any of Examples 9 to 14, wherein the first audio data is received from a first microphone, and wherein the second audio data is received from a second microphone.

Example 16 includes the device of Example 15, further includes the first microphone configured to capture first sounds of an audio environment to generate the first audio data; and the second microphone configured to capture second sounds of the audio environment to generate the second audio data.

According to Example 17, a device includes a memory configured to store audio data; and one or more processors configured to obtain reference audio data representing far end audio; obtain near end audio data; obtain, from the near end audio data, first subband audio data and second subband audio data, the first subband audio data associated with a first frequency subband and the second subband audio data associated with a second frequency subband; obtain, from the reference audio data, first subband reference audio data and second subband reference audio data, the first subband reference audio data associated with the first frequency subband and the second subband reference audio data associated with the second frequency subband; use a first machine-learning model to process the first subband audio data and the first subband reference audio data to generate first subband intermediate audio data; use a second machine-learning model to process the second subband audio data and the second subband reference audio data to generate second subband intermediate audio data, wherein each of the first subband intermediate audio data and the second subband intermediate audio data corresponds to echo suppressed audio; and generate output data based on the first subband intermediate audio data and the second subband intermediate audio data.

Example 18 includes the device of Example 17, wherein each of the first subband intermediate audio data and the second subband intermediate audio data corresponds to noise suppressed audio.

Example 19 includes the device of Example 17 or Example 18, wherein the first machine-learning model includes a long short-term memory network (LSTM), and wherein the second machine-learning model includes a convolutional neural network.

Example 20 includes the device of any of Examples 17 to 19, wherein the first machine-learning model has first model weights that are distinct from second model weights of the second machine-learning model.

Example 21 includes the device of any of Examples 17 to 20, wherein the first machine-learning model has a first model architecture that is distinct from a second model architecture of the second machine-learning model, wherein a model architecture includes a count of layers, a count of nodes, a node type, a layer type, or a combination thereof.

According to Example 22, a device includes a memory configured to store audio data; and one or more processors configured to use a first machine-learning model to process first audio data to generate first spatial sector audio data, the first spatial sector audio data associated with a first spatial sector; use a second machine-learning model to process second audio data to generate second spatial sector audio data, the second spatial sector audio data associated with a second spatial sector; and generate output data based on the first spatial sector audio data, the second spatial sector audio data, or both.

Example 23 includes the device of Example 22, wherein the one or more processors are configured to generate a first sound metric of the first spatial sector audio data; generate a second sound metric of the second spatial sector audio data; and based on a comparison of the first sound metric and the second sound metric, select one of the first spatial sector audio data or the second spatial sector audio data as the output data.

Example 24 includes the device of Example 22 or Example 23, wherein a sound metric includes a signal-to-noise ratio (SNR).

Example 25 includes the device of Example 23 or Example 24, wherein a sound metric includes a speech quality metric, a speech intelligibility metric, or both.

Example 26 includes the device of any of Examples 22 to 25, wherein the one or more processors are configured to generate the output data based on sensor input from a sensor.

Example 27 includes the device of Example 26, wherein the one or more processors are configured to select, based on the sensor input, one of the first spatial sector audio data or the second spatial sector audio data as the output data.

Example 28 includes the device of Example 26 or Example 27, wherein the one or more processors are configured to select, based on the sensor input, the first spatial sector and the second spatial sector; responsive to selection of the first spatial sector, use the first machine-learning model to generate the first spatial sector audio data; and responsive to selection of the second spatial sector, use the second machine-learning model to generate the second spatial sector audio data.

Example 29 includes the device of any of Examples 26 to 28, wherein the sensor includes a gyroscope, a camera, a microphone, or a combination thereof, and wherein the sensor input indicates a phone orientation, a detected sound source, a detected occlusion, or a combination thereof.

Example 30 includes the device of any of Examples 26 to 29, wherein the one or more processors are configured to, based on sensor input indicating that a first sound source is detected in the first spatial sector and a second sound source is detected in the second spatial sector, perform noise suppression on the first spatial sector audio data based on the second spatial sector audio data to generate the output data.

Example 31 includes the device of Example 30, wherein the one or more processors are configured to obtain, from the first spatial sector audio data, first spatial sector first subband audio data and first spatial sector second subband audio data; obtain, from the second spatial sector audio data, second spatial sector first subband audio data and second spatial sector second subband audio data; perform noise suppression on the first spatial sector first subband audio data based on second spatial sector first subband audio data to generate first subband noise suppressed audio data; perform noise suppression on the first spatial sector second subband audio data based on second spatial sector second subband audio data to generate second subband noise suppressed audio data; and generate the output data based on the first subband noise suppressed audio data and the second subband noise suppressed audio data.

Example 32 includes the device of any of Examples 22 to 31 and further includes a microphone array configured to generate the first audio data and the second audio data.

Example 33 includes the device of Example 32, wherein a first subset of the microphone array is configured to generate the first audio data, and wherein a second subset of the microphone array is configured to generate the second audio data.

Example 34 includes the device of any of Examples 22 to 33 and further includes a beamformer configured to process the audio data to generate the first audio data and the second audio data.

According to Example 35, a method includes obtaining, from first audio data, first subband audio data and second subband audio data, the first subband audio data associated with a first frequency subband and the second subband audio data associated with a second frequency subband; using a first machine-learning model to process the first subband audio data to generate first subband noise suppressed audio data; using a second machine-learning model to process the second subband audio data to generate second subband noise suppressed audio data; and generating output data based on the first subband noise suppressed audio data and the second subband noise suppressed audio data.

Example 36 includes the method of Example 35, wherein the first machine-learning model has first model weights that are distinct from second model weights of the second machine-learning model.

Example 37 includes the method of Example 35 or Example 36, wherein the first machine-learning model has a first model architecture that is distinct from a second model architecture of the second machine-learning model, wherein a model architecture includes a count of layers, a count of nodes, a node type, a layer type, or a combination thereof.

Example 38 includes the method of any of Examples 35 to 37, wherein the first machine-learning model includes a long short-term memory network (LSTM), and wherein the second machine-learning model includes a convolutional neural network.

Example 39 includes the method of any of Examples 35 to 38, further includes obtaining a context indicator associated with the first audio data; and obtaining first model parameters of the first machine-learning model based on the context indicator.

Example 40 includes the method of any of Examples 35 to 39, further includes obtaining a context indicator associated with the first audio data; and obtaining, based on the context indicator, the first machine-learning model to process the first subband audio data.

Example 41 includes the method of any of Examples 35 to 40 and further includes using procedural signal processing to process third subband audio data to generate third subband noise suppressed audio data, wherein the output data is further based on the third subband noise suppressed audio data.

Example 42 includes the method of any of Examples 35 to 41, further includes sending the second subband audio data to a second device that includes the second machine-learning model; and receiving the second subband noise suppressed audio data from the second device.

Example 43 includes the method of any of Examples 35 to 42, further includes obtaining, from second audio data, third subband audio data and fourth subband audio data, the third subband audio data associated with the first frequency subband and the fourth subband audio data associated with the second frequency subband; using a third machine-learning model to process the third subband audio data to generate third subband noise suppressed audio data; using a fourth machine-learning model to process the fourth subband audio data to generate fourth subband noise suppressed audio data; determining first subband intermediate audio data based on the first subband noise suppressed audio data, the third subband noise suppressed audio data, or both; and determining second subband intermediate audio data based on the second subband noise suppressed audio data, the fourth subband noise suppressed audio data, or both, wherein the output data is based on the first subband intermediate audio data and the second subband intermediate audio data.

Example 44 includes the method of Example 43 and further includes selecting one of the first subband noise suppressed audio data or the third subband noise suppressed audio data as the first subband intermediate audio data.

Example 45 includes the method of Example 43 or Example 44, further includes generating a first sound metric of the first subband noise suppressed audio data; generating a third sound metric of the third subband noise suppressed audio data; and based on a comparison of the first sound metric and the third sound metric, selecting one of the first subband noise suppressed audio data or the third subband noise suppressed audio data as the first subband intermediate audio data.

Example 46 includes the method of Example 45, wherein a sound metric includes a signal-to-noise ratio (SNR).

Example 47 includes the method of Example 45 or Example 46, wherein a sound metric includes a speech quality metric, a speech intelligibility metric, or both.

Example 48 includes the method of Example 43 and further includes generating the first subband intermediate audio data based on a weighted combination of the first subband noise suppressed audio data and the third subband noise suppressed audio data.

Example 49 includes the method of any of Examples 43 to 48, wherein the first audio data is received from a first microphone, and wherein the second audio data is received from a second microphone.

Example 50 includes the method of Example 49, further includes using the first microphone to capture first sounds of an audio environment to generate the first audio data; and using the second microphone to capture second sounds of the audio environment to generate the second audio data.

According to Example 51, a method includes obtaining reference audio data representing far end audio; obtaining near end audio data; obtaining, from the near end audio data, first subband audio data and second subband audio data, the first subband audio data associated with a first frequency subband and the second subband audio data associated with a second frequency subband; obtaining, from the reference audio data, first subband reference audio data and second subband reference audio data, the first subband reference audio data associated with the first frequency subband and the second subband reference audio data associated with the second frequency subband; using a first machine-learning model to process the first subband audio data and the first subband reference audio data to generate first subband intermediate audio data; using a second machine-learning model to process the second subband audio data and the second subband reference audio data to generate second subband intermediate audio data, wherein each of the first subband intermediate audio data and the second subband intermediate audio data corresponds to echo suppressed audio; and generating output data based on the first subband intermediate audio data and the second subband intermediate audio data.

Example 52 includes the method of Example 51, wherein each of the first subband intermediate audio data and the second subband intermediate audio data corresponds to noise suppressed audio.

Example 53 includes the method of Example 51 or Example 52, wherein the first machine-learning model includes a long short-term memory network (LSTM), and wherein the second machine-learning model includes a convolutional neural network.

Example 54 includes the method of any of Examples 51 to 53, wherein the first machine-learning model has first model weights that are distinct from second model weights of the second machine-learning model.

Example 55 includes the method of any of Examples 51 to 54, wherein the first machine-learning model has a first model architecture that is distinct from a second model architecture of the second machine-learning model, wherein a model architecture includes a count of layers, a count of nodes, a node type, a layer type, or a combination thereof.

According to Example 56, a method includes using a first machine-learning model to process first audio data to generate first spatial sector audio data, the first spatial sector audio data associated with a first spatial sector; using a second machine-learning model to process second audio data to generate second spatial sector audio data, the second spatial sector audio data associated with a second spatial sector; and generating output data based on the first spatial sector audio data, the second spatial sector audio data, or both.

Example 57 includes the method of Example 56, further includes generating a first sound metric of the first spatial sector audio data; generating a second sound metric of the second spatial sector audio data; and based on a comparison of the first sound metric and the second sound metric, selecting one of the first spatial sector audio data or the second spatial sector audio data as the output data.

Example 58 includes the method of Example 56 or Example 57, wherein a sound metric includes a signal-to-noise ratio (SNR).

Example 59 includes the method of Example 57 or Example 58, wherein a sound metric includes a speech quality metric, a speech intelligibility metric, or both.

Example 60 includes the method of any of Examples 56 to 59 and further includes generating the output data based on sensor input from a sensor.

Example 61 includes the method of Example 60 and further includes selecting, based on the sensor input, one of the first spatial sector audio data or the second spatial sector audio data as the output data.

Example 62 includes the method of Example 60 or Example 61, further includes selecting, based on the sensor input, the first spatial sector and the second spatial sector; responsive to selection of the first spatial sector, using the first machine-learning model to generate the first spatial sector audio data; and responsive to selection of the second spatial sector, using the second machine-learning model to generate the second spatial sector audio data.

Example 63 includes the method of any of Examples 60 to 62, wherein the sensor includes a gyroscope, a camera, a microphone, or a combination thereof, and wherein the sensor input indicates a phone orientation, a detected sound source, a detected occlusion, or a combination thereof.

Example 64 includes the method of any of Examples 60 to 63 and further includes, based on sensor input indicating that a first sound source is detected in the first spatial sector and a second sound source is detected in the second spatial sector, performing noise suppression on the first spatial sector audio data based on the second spatial sector audio data to generate the output data.

Example 65 includes the method of Example 64, further includes obtaining, from the first spatial sector audio data, first spatial sector first subband audio data and first spatial sector second subband audio data; obtaining, from the second spatial sector audio data, second spatial sector first subband audio data and second spatial sector second subband audio data; performing noise suppression on the first spatial sector first subband audio data based on second spatial sector first subband audio data to generate first subband noise suppressed audio data; performing noise suppression on the first spatial sector second subband audio data based on second spatial sector second subband audio data to generate second subband noise suppressed audio data; and generating the output data based on the first subband noise suppressed audio data and the second subband noise suppressed audio data.

Example 66 includes the method of any of Examples 56 to 65 and further includes receiving the first audio data and the second audio data from a microphone array.

Example 67 includes the method of Example 66, wherein the first audio data is received from a first subset of the microphone array, and wherein the second audio data is received from a second subset of the microphone array.

Example 68 includes the method of any of Examples 56 to 67 and further includes using a beamformer to process the audio data to generate the first audio data and the second audio data.

According to Example 69, a non-transitory computer-readable medium stores instructions that, when executed by one or more processors, cause the one or more processors to obtain, from first audio data, first subband audio data and second subband audio data, the first subband audio data associated with a first frequency subband and the second subband audio data associated with a second frequency subband; use a first machine-learning model to process the first subband audio data to generate first subband noise suppressed audio data; use a second machine-learning model to process the second subband audio data to generate second subband noise suppressed audio data; and generate output data based on the first subband noise suppressed audio data and the second subband noise suppressed audio data.

According to Example 70, a non-transitory computer-readable medium stores instructions that, when executed by one or more processors, cause the one or more processors to obtain reference audio data representing far end audio; obtain near end audio data; obtain, from the near end audio data, first subband audio data and second subband audio data, the first subband audio data associated with a first frequency subband and the second subband audio data associated with a second frequency subband; obtain, from the reference audio data, first subband reference audio data and second subband reference audio data, the first subband reference audio data associated with the first frequency subband and the second subband reference audio data associated with the second frequency subband; use a first machine-learning model to process the first subband audio data and the first subband reference audio data to generate first subband intermediate audio data; use a second machine-learning model to process the second subband audio data and the second subband reference audio data to generate second subband intermediate audio data, wherein each of the first subband intermediate audio data and the second subband intermediate audio data corresponds to echo suppressed audio; and generate output data based on the first subband intermediate audio data and the second subband intermediate audio data.

According to Example 71, a non-transitory computer-readable medium stores instructions that, when executed by one or more processors, cause the one or more processors to use a first machine-learning model to process first audio data to generate first spatial sector audio data, the first spatial sector audio data associated with a first spatial sector; use a second machine-learning model to process second audio data to generate second spatial sector audio data, the second spatial sector audio data associated with a second spatial sector; and generate output data based on the first spatial sector audio data, the second spatial sector audio data, or both.

According to Example 72, an apparatus includes means for obtaining first subband audio data and second subband audio data from first audio data, the first subband audio data associated with a first frequency subband and the second subband audio data associated with a second frequency subband; means for using a first machine-learning model to process the first subband audio data to generate first subband noise suppressed audio data; means for using a second machine-learning model to process the second subband audio data to generate second subband noise suppressed audio data; and means for generating output data based on the first subband noise suppressed audio data and the second subband noise suppressed audio data.

According to Example 73, an apparatus includes means for obtaining reference audio data representing far end audio; means for obtaining near end audio data; means for obtaining, from the near end audio data, first subband audio data and second subband audio data, the first subband audio data associated with a first frequency subband and the second subband audio data associated with a second frequency subband; means for obtaining, from the reference audio data, first subband reference audio data and second subband reference audio data, the first subband reference audio data associated with the first frequency subband and the second subband reference audio data associated with the second frequency subband; means for using a first machine-learning model to process the first subband audio data and the first subband reference audio data to generate first subband intermediate audio data; means for using a second machine-learning model to process the second subband audio data and the second subband reference audio data to generate second subband intermediate audio data, wherein each of the first subband intermediate audio data and the second subband intermediate audio data corresponds to echo suppressed audio; and means for generating output data based on the first subband intermediate audio data and the second subband intermediate audio data.

According to Example 74, an apparatus includes means for using a first machine-learning model to process first audio data to generate first spatial sector audio data, the first spatial sector audio data associated with a first spatial sector; means for using a second machine-learning model to process second audio data to generate second spatial sector audio data, the second spatial sector audio data associated with a second spatial sector; and means for generating output data based on the first spatial sector audio data, the second spatial sector audio data, or both.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store audio data; and
one or more processors configured to:
use a first machine-learning model to process first audio data to generate first spatial sector audio data, the first spatial sector audio data associated with a first spatial sector;
use a second machine-learning model to process second audio data to generate second spatial sector audio data, the second spatial sector audio data associated with a second spatial sector; and
generate output data based on the first spatial sector audio data, the second spatial sector audio data, or both.

2. The device of claim 1, wherein the one or more processors are configured to:
generate a first sound metric of the first spatial sector audio data;
generate a second sound metric of the second spatial sector audio data; and
based on a comparison of the first sound metric and the second sound metric, select one of the first spatial sector audio data or the second spatial sector audio data as the output data.

3. The device of claim 2, wherein a sound metric includes a signal-to-noise ratio (SNR).

4. The device of claim 2, wherein a sound metric includes a speech quality metric, a speech intelligibility metric, or both.

5. The device of claim 1, wherein the one or more processors are configured to generate the output data based on sensor input from a sensor.

6. The device of claim 5, wherein the one or more processors are configured to select, based on the sensor input, one of the first spatial sector audio data or the second spatial sector audio data as the output data.

7. The device of claim 5, wherein the one or more processors are configured to:
select, based on the sensor input, the first spatial sector and the second spatial sector;
responsive to selection of the first spatial sector, use the first machine-learning model to generate the first spatial sector audio data; and
responsive to selection of the second spatial sector, use the second machine-learning model to generate the second spatial sector audio data.

8. The device of claim 5, wherein the sensor includes a gyroscope, a camera, a microphone, or a combination thereof, and wherein the sensor input indicates a phone orientation, a detected sound source, a detected occlusion, or a combination thereof.

9. The device of claim 5, wherein the one or more processors are configured to, based on sensor input indicating that a first sound source is detected in the first spatial sector and a second sound source is detected in the second spatial sector, perform noise suppression on the first spatial sector audio data based on the second spatial sector audio data to generate the output data.

10. The device of claim 9, wherein the one or more processors are configured to:
obtain, from the first spatial sector audio data, first spatial sector first subband audio data and first spatial sector second subband audio data;
obtain, from the second spatial sector audio data, second spatial sector first subband audio data and second spatial sector second subband audio data;
perform noise suppression on the first spatial sector first subband audio data based on second spatial sector first subband audio data to generate first subband noise suppressed audio data;
perform noise suppression on the first spatial sector second subband audio data based on second spatial sector second subband audio data to generate second subband noise suppressed audio data; and
generate the output data based on the first subband noise suppressed audio data and the second subband noise suppressed audio data.

11. The device of claim 1, further comprising a microphone array configured to generate the first audio data and the second audio data.

12. The device of claim 11, wherein a first subset of the microphone array is configured to generate the first audio data, and wherein a second subset of the microphone array is configured to generate the second audio data.

13. The device of claim 1, further comprising a beamformer configured to process the audio data to generate the first audio data and the second audio data.

14. A method comprising:
using a first machine-learning model to process first audio data to generate first spatial sector audio data, the first spatial sector audio data associated with a first spatial sector;
using a second machine-learning model to process second audio data to generate second spatial sector audio data, the second spatial sector audio data associated with a second spatial sector; and
generating output data based on the first spatial sector audio data, the second spatial sector audio data, or both.

15. The method of claim 14, further comprising:
generating a first sound metric of the first spatial sector audio data;
generating a second sound metric of the second spatial sector audio data; and
based on a comparison of the first sound metric and the second sound metric, selecting one of the first spatial sector audio data or the second spatial sector audio data as the output data.

16. The method of claim 15, wherein a sound metric includes a signal-to-noise ratio (SNR).

17. The method of claim 15, wherein a sound metric includes a speech quality metric, a speech intelligibility metric, or both.

18. The method of claim 14, further comprising generating the output data based on sensor input from a sensor.

19. The method of claim 18, further comprising selecting, based on the sensor input, one of the first spatial sector audio data or the second spatial sector audio data as the output data.

20. A non-transitory computer-readable medium stores instructions that, when executed by one or more processors, cause the one or more processors to:
use a first machine-learning model to process first audio data to generate first spatial sector audio data, the first spatial sector audio data associated with a first spatial sector;
use a second machine-learning model to process second audio data to generate second spatial sector audio data, the second spatial sector audio data associated with a second spatial sector; and
generate output data based on the first spatial sector audio data, the second spatial sector audio data, or both.
